(19) United States
(12) Patent Application Publication
(10) Pub. No.: US 2016/0304752 A1
(43) Pub. Date: Oct. 20, 2016

(54) BLUE LIGHT-BLOCKING RESIN COMPOSITION

(71) Applicant: RIKEN TECHNOS CORPORATION, Chiyoda-ku, Tokyo (JP)

(72) Inventor: Kazutaka YAMADA, Tokyo (JP)

(73) Assignee: RIKEN TECHNOS CORPORATION, Tokyo (JP)

(21) Appl. No.: 15/037,641

(22) PCT Filed: Aug. 6, 2014
(86) PCT No.: PCT/JP2014/076659

§ 371 Date: May 18, 2016

(30) Foreign Application Priority Data
Nov. 18, 2013 (JP) 2013-237955
Mar. 13, 2014 (JP) 2014-049658

(51) Int. Cl. C09J 11/04; C08K 3/22; C09J 4/00; G02B 5/22; C09J 133/00; B05D 1/02; B05D 1/28; C09J 9/00; C09J 167/00

(52) U.S. Cl. CPC C09J 11/04; C09J 9/00; C08K 3/22; C09J 4/00; C09J 167/00; C09J 133/00; B05D 1/02; B05D 1/28; G02B 5/22; C08K 2003/2241; C08K 2003/2296; C08K 2003/2227; C08K 2201/005

(57) ABSTRACT

Embodiments of the invention provide a resin composition for optical articles, which has a blue light-blocking function, is white and transparent, and does not look yellow; and a laminate. According to at least one embodiment, the resin composition includes (A) 1 to 5 parts by mass of white inorganic microparticles and (B) 100 parts by mass of a transparent base resin. The resin composition is characterized in that (i) the white inorganic microparticles have an average particle diameter of 10 to 80 nm and (ii) the difference between the refractive index of the white inorganic microparticles and the refractive index of the base resin is 0.1 or more. According to at least one embodiment, there is provided a laminate which includes a hard coat layer or a cohesive/adhesive agent layer each made from the resin composition and a poly(meth)acrylic imide resin film layer.

### CROSS REFERENCE TO RELATED APPLICATION

This application claims the benefit of and priority to PCT/JP2014/076659 filed on Oct. 6, 2014, entitled (translation), “BLUE LIGHT-BLOCKING RESIN COMPOSITION,” which claims the benefit of and priority to Japanese Patent Applications No. 2013-237955, filed on Nov. 18, 2013, and No. 2014-049658, filed on Mar. 13, 2014, all of which are hereby incorporated by reference in their entirety into this application.

### BACKGROUND

1. Field of the Invention

Embodiments of the invention relate to a resin composition having a blocking function of blue light. In particular, embodiments of the invention relate to a resin composition for optical articles which have a blue light-blocking function and are white and transparent and do not look yellow.

Embodiments of the invention further relate to a poly(meth)acrylimide resin laminate having a blocking function of blue light which uses the above resin composition. In particular, embodiments of the invention relate to a poly(meth)acrylimide resin laminate for optical articles which has a blue light-blocking function and is white and transparent and does not look yellow.

2. Description of the Related Art

In recent years, light emitting diode (LED) displays have been commonly used. The blue light (with a wavelength from 380 to 495 nanometers) emitted from an LED display has been revealed to impose a heavy burden on the human eye and thus be harmful. For this reason, a technique has been proposed to block or absorb and reduce the blue light without reducing the total visible light transmittance, as described for example, in JP 2007-093927 A. In this technique, the function of blocking or absorbing and reducing the blue light is expressed, however, at the same time an article imparted with such a function is yellow transparent but not white and transparent, hence problematic. When a display is looked at through glasses or a protective film tinted yellow, the original color tone is lost. Additionally, plastic products, in most cases, turn yellow as they deteriorate. Thus, the color yellow is not generally preferable because a product looks deteriorated even when it is new.

Conventionally, for a face panel of an LED display, articles composed of a glass base material have been used because property requirements such as heat resistance, dimensional stability, high transparency, high surface hardness, and high rigidity are met. However, glasses pose inconvenience such as being low in impact resistance and fragile; low in processability; difficult in handling; high in specific gravity and heavy; and difficult to respond the requirement for curved and flexible displays. Thus, materials which replace glasses have been studied actively. For example, many hard coat laminates have been proposed each of which has a hard coat with high surface hardness and abrasion resistance formed on the surface of a transparent resin film substrate such as triacetyl cellulose, polyethylene terephthalate, polycarbonate, polymethyl methacrylate, and norbornene polymers, as described, for example, in JP 2013-208896 A. However, heat resistance and dimensional stability of these laminates are insufficient. No material, which has a blue light-blocking function and is white and transparent ant does not look yellow, has been reported.

### SUMMARY

Embodiments of the invention provide a resin composition for optical articles, which has a blue light-blocking function and is white and transparent and does not look yellow.

Embodiments of the invention further provide a laminate for optical articles, which has good transparency, surface hardness, rigidity, heat resistance, and dimensional stability, in addition to having the blue light-blocking function and being white and transparent and not looking yellow.

According to at least one embodiment, a specific amount of white inorganic fine particles having a specific particle size and a significant refractive index difference from a transparent base resin addresses the aforementioned problems identified above.

According to at least one embodiment, disposing a layer formed of a transparent resin composition, which contains a specific amount of white inorganic fine particles having a specific particle size and a significant refractive index difference from a transparent base resin, on at least one of the surfaces of a poly(meth)acrylimide resin film also addresses the aforementioned problems identified above.

According to at least one embodiment, there is provided a resin composition including (A) 1 to 50 parts by mass of white inorganic fine particles, and (B) 100 parts by mass of a transparent base resin, wherein (i) an average particle size of the white inorganic fine particles is 10 to 80 nm, and (ii) a difference between a refractive index of the white inorganic fine particles and a refractive index of the base resin is 0.1 or more.

According to at least one embodiment, component (B) is a transparent curable resin.

According to at least one embodiment, component (B) is a transparent thermoplastic resin.

According to at least one embodiment, component (B) is a transparent adhesive.

According to at least one embodiment, there is provided a laminate including a (α) hard coat layer and a (β) poly(meth)acrylimide resin film layer, wherein the (α) hard coat layer is formed of a transparent curable resin composition including (a) 1 to 50 parts by mass of white inorganic fine particles having an average particle size of 10 to 80 nm, and (b) 100 parts by mass of a transparent curable resin, wherein (1) a difference between a refractive index of the component (a) and a refractive index of the component (b) is 0.1 or more.

According to at least one embodiment, there is provided a laminate including a (β) poly(meth)acrylimide resin film layer and an (γ) adhesive layer, wherein the (γ) adhesive layer is formed of a transparent adhesive resin composition including (a) 1 to 50 parts by mass of white inorganic fine particles having an average particle size of 10 to 80 nm, and (b) 100 parts by mass of a transparent adhesive resin, wherein (1) a difference between a refractive index of the component (a) and a refractive index of the component (b) is 0.1 or more.

According to at least one embodiment, the (β) poly(meth)acrylimide resin film layer is a multilayer film having a first poly(meth)acrylimide resin layer (β1), an aromatic polycarbonate resin layer (δ), and a second poly(meth)acrylimide resin layer (β2) directly superimposed in this sequence.

According to at least one embodiment, there is provided a blue light-blocking film formed of the resin composition discussed above and described in more detail below.

According to at least one embodiment, there is a provided a blue light-blocking film including the resin composition or the laminate discussed above and described in more detail below.

According to at least one embodiment, there is provided an article with the blue light-blocking film formed of the resin composition discussed above and described in more detail below.

According to at least one embodiment, there is provided a use of the resin composition or the laminate discussed above and described in more detail below for a blue light-blocking member.

### DETAILED DESCRIPTION

Although the following detailed description contains many specific details for purposes of illustration, it is understood that one of ordinary skill in the relevant art will appreciate that many examples, variations, and alterations to the following details are within the scope and spirit of the invention. Accordingly, the exemplary embodiments of the invention described herein are set forth without any loss of generality, and without imposing limitations, relating to the claimed invention. Like numbers refer to like elements throughout. Prime notation, if used, indicates similar elements in alternative embodiments.

According to at least one embodiment, there is provided a resin composition including (A) 1 to 50 parts by mass of white inorganic fine particles, and (B) 100 parts by mass of a transparent base resin, wherein (i) an average particle size of the white inorganic fine particles is 10 to 80 nm, and (ii) a difference between a refractive index of the white inorganic fine particles and a refractive index of the base resin is 0.1 or more.

(A) White Inorganic Fine Particles

According to at least one embodiment, the white inorganic fine particles of the component (A) used according to various embodiments the invention are inorganic fine particles, which are visually white. The white inorganic fine particles block the blue light, but allow visible lights other than the blue light to transmit, and act to cause the resin composition to look white and transparent and not to be tinted yellow.

The term “visually white” referred to herein means a color tone of the fine particles, which looks whiter than one of DN-85, D05-90A, D05-92B, D15-90A, D15-92B, D19-85A, D19-92B, D19-90C, D22-90B, D22-90C, D22-90D, D25-85A, D25-90B, D25-90C, D27-90B, D29-92B, D35-90A, D35-92B, D45-90A, D55-90A, D55-90B, D65-90A, D65-90B, D75-85A, D75-90B, D75-90D, D85-85A, D85-92B, D85-90D, and D95-90B when the fine particles are placed in a receiver in accordance with JIS K5101-12-1: 2004 and visually compared with the Standard Paint Colors D-Edition issued by the Japan Paint Manufacturers Association. The term “visually white” preferably means a color tone of the fine particles looking whiter than any one of these colors. The term “visually white” more preferably means a color tone of the fine particles looking whiter than any one of these colors and looking whiter than DN-87.

According to at least one embodiment, the resin composition has an average particle size of the white inorganic fine particles of the component (A) being 10 to 80 nm. When an average particle size of the white inorganic fine particles is within the range, the specific actions are expressed, such as blocking the blue light, allowing visible lights other than the blue light to transmit, and causing the resin composition to look white and transparent and not to be tinted yellow. According to at least one embodiment, the average particle size of the white inorganic fine particles is preferably 30 to 55 nm.

According to at least one embodiment, the average particle size of the fine particles is intended to herein mean the particle size at which the accumulation of smaller particles reaches 50% by mass on a particle size distribution curve measured using a laser diffraction/scattering particle size analyzer, for example, “MT3200II” (trade name) of Nikkiso Co., Ltd.

Examples of the white inorganic fine particles usable to be the component (A) according to various embodiments of the invention include titanium oxide, aluminum oxide, zinc oxide, magnesium oxide, barium sulfate, calcium carbonate, zinc sulfide, magnesium hydroxide, aluminum hydroxide, hydrotalcite, antimony oxide, indium oxide, tin oxide, and indium tin oxide.

Of these, rutile titanium oxide, aluminum oxide, and zinc oxide are preferable. One of these, or two or more in combination of these may be used as the component (A).

The resin composition according to various embodiments of the invention contains the white inorganic fine particles of the component (A) in a proportion of 1 to 50 parts by mass with respect to 100 parts by mass of the transparent base resin of the component (B). When the white inorganic fine particles are contained in a proportion of 50 parts by mass or less, the transparent base resin can load the white inorganic fine particles in good conditions and hence the appearance of an article to be obtained from the resin composition is favorable. The proportion of the white inorganic fine particles is preferably 40 parts by mass or less, more preferably 30 parts by mass or less, and further preferably 20 parts by mass or less. When the white inorganic fine particles are contained in a proportion of 1 part by mass or more, the blue light-blocking performance can be expressed. The proportion of the white inorganic fine particles is preferably 5 parts by mass or more, more preferably 10 parts by mass or more, and further preferably 15 parts by mass or more.

Further, the resin composition according to various embodiments of the invention is characterized in that a difference between a refractive index of the white inorganic fine particles of the component (A) and a refractive index of the transparent base resin of the component (B) is 0.1 or more. When the difference between a refractive index of the white inorganic fine particles and a refractive index of the transparent base resin is 0.1 or more, the resin composition, even when the blue light is blocked, is not tinted yellow, which is the complementary color of blue, and looks white and transparent. The larger a refractive index difference is, more preferable. The refractive index difference is preferably 0.2 or more.

According to at least one embodiment, the refractive index of the white inorganic fine particles of the component (A) is intended to herein mean a value obtained by preparing a transparent organic solvent dispersion, measuring a refractive index thereof at a temperature of 20° C. using sodium D line (with a wavelength of 589.3 nm), and extrapolating the obtained refractive index to 100% by volume of the white inorganic fine particles based on the specific gravities of the white inorganic fine particles and the organic solvent so as to calculate the value. The refractive index of the transparent base resin of the component (B) is a value obtained by preparing a film composed only of the transparent base rein and measuring at a temperature of 20° C. using sodium D line (with a wavelength of 589.3 nm) in accordance with JIS K7142: 2008.

(B) Transparent Base Resin

As the transparent base resin of the component (B) according to various embodiments of the invention, any resin can be used without limitation as long as the resin is a highly transparent resin with good loading property for the white inorganic fine particles of the component (A) that is the blue light-blocking agent, and the above requirement (ii) is met.

The “loading property” of the resin is intended to herein mean the resin's ability of loading a filler therein. Additionally, the term “good loading property” intends to be capable of loading a large amount of filler and that the original resin properties are not easy to become lowered even when the resin loads the filler therein.

Preferable examples of the transparent base resin of the component (B) include a transparent curable resin, in particular, a transparent active energy ray-curable resin. The resin composition comprising an active energy ray-curable resin, which is usable as the component (B) (hereinafter referred to as “an active energy ray-curable resin composition”) is one capable of being polymerized and cured with an active energy ray such as an ultraviolet ray and an electron beam to form a hard coat. Examples thereof include a composition comprising an active energy ray-curable resin together with a compound having two or more isocyanate groups (—N═C═O) per molecule and/or a photopolymerization initiator.

Examples of the active energy ray-curable resin include one or more selected from (meth)acryloyl group-containing prepolymers or oligomers such as polyurethane (meth)acrylate, polyester (meth)acrylate, polyacryl (meth)acrylate, an epoxy (meth)acrylate, polyalkylene glycol poly(meth)acrylate, and polyether (meth)acrylate; (meth)acryloyl group-containing monofunctional reactive monomers such as methyl (meth)acrylate, ethyl (meth)acrylate, n-butyl (meth)acrylate, hexyl (meth)acrylate, 2-ethylhexyl (meth)acrylate, lauryl (meth)acrylate, isobornyl (meth)acrylate, dicyclopentenyl (meth)acrylate, dicyclopentenyloxyethyl (meth)acrylate, phenyl (meth)acrylate, phenylcellosolve (meth)acrylate, 2-methoxy ethyl (meth)acrylate, hydroxyethyl (meth)acrylate, hydroxypropyl (meth)acrylate, 2-acryloyloxyethylhydrogenphthalate, dimethylaminoethyl (meth)acrylate, trifluoroethyl (meth)acrylate, and trimethylsiloxyethyl methacrylate, and prepolymers or oligomers having one or more of these as constituent monomers; monofunctional reactive monomers such as N-vinyl pyrrolidone and styrene; (meth)acryloyl group-containing bifunctional reactive monomers such as diethylene glycol di(meth)acrylate, neopentyl glycol di(meth)acrylate, 1,6-hexanediol di(meth)acrylate, polyethylene glycol di(meth)acrylate, 2,2′-bis(4-(meth)acryloyloxypolyethyleneoxyphenyl)propane, and 2,2′-bis(4-(meth)acryloyloxypolypropyleneoxyphenyl)propane; (meth)acryloyl group-containing trifunctional reactive monomers such as trimethylolpropane tri(meth)acrylate and trimethylolethane tri(meth)acrylate; (meth)acryloyl group-containing tetrafunctional reactive monomers such as pentaerythritol tetra(meth)acrylate; and (meth)acryloyl group-containing hexafunctional monomers such as dipentaerythritol hexaacrylate, and resins having one or more of the above as the constituent monomers. One of these, or two or more in combination of these can be used as the active energy ray-curable resin.

The term (meth)acrylate is intended to herein mean acrylate or methacrylate.

Examples of the compound having two or more isocyanate groups per molecule include methylenebis-4-cyclohexylisocyanate; polyisocyanates such as trimethylolpropane adduct of tolylenediisocyanate, trimethylolpropane adduct of hexamethylene diisocyanate, trimethylolpropane adduct of isophorone diisocyanate, isocyanurate of trilenediisocyanate, isocyanurate of hexamethylene diisocyanate, isocyanurate of isophorone diisocyanate, and biuret of hexamethylene diisocyanate; and urethane crosslinking agents such as blocked isocyanates of the above polyisocyanates. These may be used singly, or in combinations of two or more. During crosslinking, a catalyst such as dibutyltin dilaurate or dibutyltin diethylhexoate may be added to the reaction system as necessary.

Examples of the photopolymerization initiator include benzophenone compounds such as benzophenone, methyl-o-benzoylbenzoate, 4-methylbenzophenone, 4,4′-bis(diethylamino)benzophenone, methyl-o-benzoylbenzoate, 4-phenylbenzophenone, 4-benzoyl-4′-methyldiphenyl sulfide, 3,3′,4,4′-tetra(tert-butylperoxycarbonyl)benzophenone, and 2,4,6-trimethylbenzophenone; benzoin compounds such as benzoin, benzoin methyl ether, benzoin ethyl ether, benzoin isopropyl ether, and benzyl methyl ketal; acetophenone compounds such as acetophenone, 2,2-dimethoxy-2-phenylacetophenone, and 1-hydroxycyclohexylphenyl ketone; anthraquinone compounds such as methylanthraquinone, 2-ethylanthraquinone, and 2-amylanthraquinone; thioxanthone compounds such as thioxanthone, 2,4-diethylthioxanthone, and 2,4-diisopropylthioxanthone; alkylphenone compounds such as acetophenone dimethyl ketal; triazine compounds; biimidazole compounds; acylphosphine oxide compounds; titanocene compounds; oxime ester compounds; oxime phenylacetate compounds; hydroxy ketone compounds; and aminobenzoate compounds. These may be used singly, or in combinations of two or more.

According to at least one embodiment, the active energy ray-curable resin composition may contain one or more of additives as necessary such as an antistatic agent, a surfactant, a leveling agent, a thixotropic additive, an antifouling agent, a printability improver, an antioxidant, a weather resistant stabilizer, a light resistant stabilizer, an ultraviolet absorber, a thermostabilizer, a colorant, and a filler.

According to at least one embodiment, the active energy ray-curable resin composition may further contain a solvent as necessary to be diluted to a concentration at which coating is easily applied. The type of the solvent is not particularly limited as long as it does not react with the components of the curable resin composition or with any other optional component(s) or catalyze (facilitate) the self-reaction (including deterioration reaction) of these components. Examples of the solvent include 1-methoxy-2-propanol, ethyl acetate, n-butyl acetate, toluene, methyl ethyl ketone, methyl isobutyl ketone, diacetone alcohol, and acetone.

According to at least one embodiment, the active energy ray-curable composition of the component (B) can be obtained by mixing and stirring these components.

According to at least one embodiment, the resin composition containing the white inorganic fine particles of the component (A) and the active energy ray-curable composition of the component (B) can be obtained by mixing and stirring these components.

According to at least one embodiment, in an embodiment where the active energy ray-curable resin composition is used to be the component (B), a coat (or film) of the resin composition according to various embodiments of the invention can be formed by employing any web coating method such as roll coating, gravure coating, reverse coating, roll brush coating, spray coating, air knife coating, and die coating, on any web substrate such as a biaxially oriented polyethylene terephthalate film. When the film is formed, a known diluent solvent such as methyl ethyl ketone, methyl isobutyl ketone, ethyl acetate, n-butyl acetate, isopropanol, or 1-methoxy-2-propanol can be used. The thickness of the above coat is not particularly limited but, considering the use of such a known web coating method, typically 0.5 to 100 μm.

Other preferable examples of the transparent base resin of the component (B) include transparent thermoplastic resins for extrusion, injection molding, and blow molding.

Examples of such a transparent thermoplastic resin include the following types:

(b1) a transparent aromatic polycarbonate resin;

(b2) a transparent polyester resin;

(b3) a transparent acrylic resin; and

(b4) a transparent vinylidene fluoride resin.

Examples of the transparent aromatic polycarbonate resin of the component (b1) include one, and two or more in mixture, of aromatic polycarbonate resins such as polymers obtained by interfacial polymerization of an aromatic dihydroxy compound such as bisphenol A and phosgene; and polymers obtained by transesterification of an aromatic dihydroxy compound such as bisphenol A and a carbonic diester such as diphenyl carbonate.

Preferable examples of the component (B) include resin compositions composed of the transparent aromatic polycarbonate resin of the component (b1) and a core-shell rubber (c1).

Examples of the core-shell rubber (c1) to be used include one, and two or more in mixture, of methacrylate-styrene/butadiene rubber graft copolymers, acrylonitrile-styrene/butadiene rubber graft copolymers, acrylonitrile-styrene/ethylene-propylene rubber graft copolymers, acrylonitrile-styrene/acrylate graft copolymers, methacrylate/acrylate rubber graft copolymers, and methacrylate-acrylonitrile/acrylate rubber graft copolymers.

The blend ratio of the (b1) transparent aromatic polycarbonate resin and the (c1) coreshell rubber is, from the viewpoint of transparency and impact resistance, preferably (1) 50 to 99 parts by mass, (c1) 50 to 1 part by mass, and more preferably (b1) 70 to 90 parts by mass, (c1) 30 to 10 parts by mass, when the total mass of the two components is 100 parts by mass.

Examples of optional components that may be used with the transparent aromatic polycarbonate resin of the component (b1) include thermoplastic resins other than the component (b1) and the component (c1); pigments, inorganic fillers, organic fillers, resin fillers; and additives such as a lubricant, an antioxidant, a weather resistant stabilizer, a thermostabilizer, a release agent, an antistatic agent, and a surfactant. The amount of these optional components is typically about 0.1 to 10 parts by mass, based on 100 parts by mass of the total mass of (b1) and (c1).

Examples of the transparent polyester resin of the component (b2) include polyester copolymers of an aromatic polyvalent carboxylic acid component such as terephthalic acid, isophthalic acid, orthophthalic acid, and naphthalene dicarboxylic acid and a polyvalent alcohol component such as ethylene glycol, diethylene glycol, neopentylglycol, 1,2-butanediol, 1,3-butanediol, 1,4-butanediol, 1,5-pentanediol, 3-methyl-1,5-pentanediol, 2-methyl-1,3-propanediol, and 1,4-cyclohexanedimethanol. More specific examples thereof include one, and two or more in mixture, of, when the sum of monomers is 100% by mol, polyethylene terephthalate (PET) composed of 45 to 50% by mol of terephthalic acid and 45 to 50% of ethylene glycol; glycol-modified polyethylene terephthalate (PETG) composed of 45 to 50% by mol of terephthalic acid, 30 to 40% by mol of ethylene glycol, and 10 to 20% by mol of 1,4-cyclohexanedimethanol; glycol-modified polycyclohexylenedimethylene terephthalate (PCTG) composed of 45 to 50% by mol of terephthalic acid, 16 to 21% by mol of ethylene glycol, and 29 to 34% by mol of 1,4-cyclohexanedimethanol; acid-modified polycyclohexylenedimethylene terephthalate (PCTA) composed of 25 to 49.5% by mol of terephthalic acid, 0.5 to 25% by mol of isophthalic acid, and 45 to 50% by mol of 1,4-cyclohexanedimethanol; and acid-modified and glycol-modified polyethylene terephthalate composed of 30 to 45% by mol of terephthalic acid, 5 to 20% by mol of isophthalic acid, 35 to 48% by mol of ethylene glycol, 2 to 15% by mol of neopentyl glycol, less than 1% by mol of diethylene glycol, and less than 1% by mol of bisphenol A.

Other components can be used, as desired, with the transparent polyester resin of the component (b2). Examples of optional components that may be used include thermoplastic resins other than the component (b2); a pigment, an inorganic filler, an organic filler, a resin filler; and additives such as a lubricant, an antioxidant, a weather resistant stabilizer, a thermostabilizer, a release agent, an antistatic agent, and a surfactant. The amount of these optional components is typically about 0.1 to 10 parts by mass, based on 100 parts by mass of the component (b2).

Preferable examples of the component (B) include a resin composition composed of the transparent polyester resin of the component (b2) and the core-shell rubber (c1). Use of such a composition can improve the impact resistance. The amount of the component (c1) based on 100 parts by mass of the component (b2) is preferably 0.5 parts by mass or more to improve impact resistance, and preferably 5 parts by mass or less, and more preferably 3 parts by mass or less, to retain the transparency.

Examples of the transparent acrylic resin of the component (b3) include one, and two or more in mixture, of acrylic resins such as (meth)acrylate (co)polymers such as polymethyl (meth)acrylate, polyethyl (meth)acrylate, polypropyl (meth)acrylate, polybutyl (meth)acrylate, methyl (meth)acrylate-butyl (meth)acrylate copolymers, ethyl (meth)acrylate-butyl (meth)acrylate copolymers; and copolymers composed of (meth)acrylate such as ethylene-methyl (meth)acrylate copolymers and styrene-methyl (meth)acrylate copolymers. The term (meth)acryl is intended to herein mean acryl or methacryl. The term (co)polymer is intended to herein mean a polymer or a copolymer.

Preferable examples of the component (B) include a resin composition composed of the transparent acrylic resin of the component (b3) and the core-shell rubber (c1). The blend ratio of the component (b3) and the component (c1) is, from the viewpoint of transparency and impact resistance, preferably (b3) 50 to 85 parts by mass, (c1) 50 to 15 parts by mass, and more preferably (b3) 60 to 75 parts by mass, (c1) 40 to 25 parts by mass, based on 100 parts by mass of the total of both components.

Examples of the optional components that may be used with the transparent acrylic resin of the component (b3) include thermoplastic resins other than the component (b3) and the component (c1); pigments, inorganic fillers, organic fillers, resin fillers; and additives such as a lubricant, an antioxidant, a weather resistant stabilizer, a thermostabilizer, a release agent, an antistatic agent, a nucleating agent, and a surfactant. The amount of these optional components is typically about 0.1 to 10 parts by mass, based on 100 parts by mass of the total mass of (b3) and (c1).

Examples of the transparent vinylidene fluoride resin of the component (b4) include a homopolymer of vinylidene fluoride and a copolymer containing 70% by mol of vinylidene fluoride as the constituent unit. One of these, or two or more in combination of these resins may be used. Examples of the monomer to be copolymerized with vinylidene fluoride include ethylene tetrafluoride, propylene hexafluoride, trifluoroethylene, chlorotrifluoroethylene, and vinyl fluoride. One or more of these monomers may be used.

These transparent vinylidene fluoride resins typically have a melting point ranging from 145 to 180° C. Those having a melting point of 150 to 170° C. are preferably used from the viewpoint of processability.

The melting point is herein defined to be the peak top of the highest temperature side on the melting curve obtained by DSC measurement, using, for example, a Diamond DSC differential scanning calorimeter of PerkinElmer Japan Co., Ltd., under a temperature program in which a sample is kept for 5 minutes at 230° C., cooled to −50° C. at a temperature drop rate of 10° C./min, kept for 5 minutes at −50° C., and subsequently heated to 230° C. at a temperature elevation rate of 10° C./min.

Within the range not impairing the objectives of the invention, a lubricant, an antioxidant, a weather resistant stabilizer, a thermostabilizer, a release agent, an antistatic agent, a surfactant, a nucleating agent, a color material, a plasticizer, and the like, can be used with the transparent vinylidene fluoride resin.

According to at least one embodiment, the resin composition containing the white inorganic fine particles of the component (A) and the transparent thermoplastic resin of the component (B) can be obtained by melting and kneading each of the above components using any melt-kneader. Examples of the melt-kneader include a batch kneader such as a pressure kneader and a mixer; an extrusion kneader such as a co-rotation twin screw extruder and a counter-rotation twin screw extruder; and a calender roll kneader. These may be used in any combination. The obtained resin composition is pelletized by any method and subsequently molded to be any article by any method. Alternatively, the melt-kneaded resin composition may be directly molded to be any article by any method. The above pelletization can be carried out by a method such as hot cut, strand cut, and underwater cut.

The thickness of a film composed of the resin composition, in an embodiment where the transparent thermoplastic resin is used as the component (B), is not particularly limited. The thickness for obtaining a film roll is typically 5 to 1000 μm. The thickness for obtaining a thin sheet is typically 0.5 to 10 mm.

Other preferable examples of the transparent base resin of the component (B) include a transparent adhesive. The term “adhesive” is intended to herein encompass a pressure-sensitive adhesive and a chemically curing adhesive. Examples of the transparent adhesive include acrylic pressure-sensitive adhesives, urethane pressure-sensitive adhesives, silicone pressure-sensitive adhesives, saturated copolymerized polyester adhesive agents, and unsaturated copolymerized polyester adhesive agents. One of these, or two or more in combination of these can be used as the transparent adhesive of the component (B). The transparent adhesive of the component (B) may contain an optional component(s) which is(are) similar to those described above for the active energy ray-curable resin composition or the transparent thermoplastic resin.

According to at least one embodiment, the resin composition containing the white inorganic fine particles of the component (A) and the adhesive of the component (B) can be obtained by mixing and stirring these components.

The coat (or film) made of the resin composition, in an embodiment where the transparent adhesive is used as the component (B), can be formed by employing any web coating method such as roll coating, gravure coating, reverse coating, roll brush coating, spray coating, air knife coating, or die coating on any web substrate such as a biaxially oriented polyethylene terephthalate film. When the film is formed, a known diluent solvent such as methyl ethyl ketone, methyl isobutyl ketone, ethyl acetate, n-butyl acetate, isopropanol, or 1-methoxy-2-propanol can be used. The thickness of the above coat is not particularly limited. The thickness of the film is, considering the use of a known web coating method, typically 0.5 to 200 μm.

According to another embodiment of the invention, there is provided a laminate including an (α) hard coat layer and a (β) poly(meth)acrylimide resin film layer, wherein the (α) hard coat layer is formed of a transparent curable resin composition including (a) 1 to 50 parts by mass of white inorganic fine particles having an average particle size of 10 to 80 nm, and (b) 100 parts by mass of a transparent curable resin, wherein (1) a difference between a refractive index of the component (a) and a refractive index of the component (b) is 0.1 or more.

(a) White Inorganic Fine Particles Having an Average Particle Size of 10 to 80 nm

According to at least one embodiment, the white inorganic fine particles of the component (a) used in the present invention are inorganic fine particles, which are visually white. The white inorganic fine particles block the blue light but also allows other visible lights than the blue light to transmit, and act to cause the transparent curable resin composition and the transparent adhesive resin composition described later to look white and transparent and not to be tinted yellow.

The term “visually white” herein means a color tone of the fine particles, which looks whiter than one of DN-85, D05-90A, D05-92B, D15-90A, D15-92B, D19-85A, D19-92B, D19-90C, D22-90B, D22-90C, D22-90D, D25-85A, D25-90B, D25-90C, D27-90B, D29-92B, D35-90A, D35-92B, D45-90A, D55-90A, D55-90B, D65-90A, D65-90B, D75-85A, D75-90B, D75-90D, D85-85A, D85-92B, D85-90D, and D95-90B when the fine particles are placed in a receiver in accordance with JIS K5101-12-1: 2004 and visually compared with the Standard Paint Colors D-Edition of the Japan Paint Manufacturers Association. The term “visually white” preferably means a color tone of the fine particles looking whiter than any one of these colors. The term “visually white” more preferably means a color tone of the fine particles looking whiter than any one of these colors and looking whiter than DN-87.

According to at least one embodiment, the average particle size of the white inorganic fine particles of the component (a) is 10 to 80 nm. When the average particle size of the white inorganic fine particles is within the range, the specific actions are expressed such as blocking the blue light, allowing other visible lights than the blue light to transmit, and causing the transparent curable resin composition and the transparent adhesive resin composition to look white and transparent and not to be tinted yellow. The average particle size of the white inorganic fine particles is preferably 30 to 55 nm.

According to at least one embodiment, the average particle size of the fine particles herein is intended to herein mean the particle size at which the accumulation of smaller particles reaches 50% by mass on a particle size distribution curve measured using, for example, a laser diffraction/scattering particle size analyzer “MT3200II” (trade name) of Nikkiso Co., Ltd.

According to at least one embodiment, the white inorganic fine particles of the component (a) are not particularly limited and any of inorganic fine particles can be used, as long as they are visually white and has an average particle size of 10 to 80 nm. Examples of the white inorganic fine particles of the component (a) include titanium oxide, aluminum oxide, zinc oxide, magnesium oxide, barium sulfate, calcium carbonate, zinc sulfide, magnesium hydroxide, aluminum hydroxide, hydrotalcite, antimony oxide, indium oxide, tin oxide, and indium tin oxide.

Of these, rutile titanium oxide, aluminum oxide, and zinc oxide are preferable. One of these, or two or more in combination of these may be used as the component (a).

(b) Transparent Curable Resin

According to at least one embodiment, the transparent curable resin of the component (b) is a base resin of the transparent curable resin composition for forming the hard coat layer. The transparent curable resin is not particularly limited as long as it is capable of forming a hard coat layer excellent in transparency and colorlessness. The transparent curable resin is preferably capable of forming a hard coat layer further excellent in surface hardness and abrasion resistance. Preferable examples of the transparent curable resin include an active energy ray-curable resin.

According to at least one embodiment, the transparency and colorlessness of the hard coat layer may not be affected only by the properties of the transparent curable resin but also by the formation conditions such as other components, layer thickness, drying temperature, and irradiation dose of an active energy ray. Herein, if the total light transmittance of the formed hard coat layer (measured in accordance with JIS K7361-1: 1997 using a turbidity meter “NDH2000” (trade name) of Nippon Denshoku Industries Co., Ltd.) is 80% or more, preferably 85% or more, and more preferably 90% or more, the transparent curable resin can be considered to meet the requirement of “a transparent curable resin capable of forming a hard coat layer excellent in transparency”. Further, if the color of the formed hard coat layer is “visually white,” the transparent curable resin can be considered to meet the requirement of “a transparent curable resin capable of forming a hard coat layer excellent in colorlessness”. The term “visually white” herein means a color, which looks whiter than one of DN-85, D05-90A, D05-92B, D15-90A, D15-92B, D19-85A, D19-92B, D19-90C, D22-90B, D22-90C, D22-90D, D25-85A, D25-90B, D25-90C, D27-90B, D29-92B, D35-90A, D35-92B, D45-90A, D55-90A, D55-90B, D65-90A, D65-90B, D75-85A, D75-90B, D75-90D, D85-85A, D85-92B, D85-90D, and D95-90B when DN-95 of the Standard Paint Colors D-Edition of the Japan Paint Manufacturers Association is visually viewed through the formed hard coat layer. The term “visually white” preferably means a color looking whiter than any one of these colors. The term “visually white” more preferably means a color looking whiter than any one of these colors and looking whiter than DN-87.

According to at least one embodiment, the resin composition containing the active energy ray-curable resin, which is usable as the component (b) (hereinafter referred to as “an active energy ray-curable resin composition”), is one which can be polymerized and cured with an active energy ray such as an ultraviolet ray or an electron beam to form a hard coat. Examples thereof include a composition containing the active energy ray-curable resin together with a compound having two or more isocyanate groups (—N═C═O) per molecule and/or a photopolymerization initiator.

Examples of the active energy ray-curable resins include one or more selected from (meth)acryloyl group-containing prepolymers and oligomers such as polyurethane (meth)acrylate, polyester (meth)acrylate, polyacryl (meth)acrylate, epoxy (meth)acrylate, polyalkylene glycol poly(meth)acrylate, and polyether (meth)acrylate; (meth)acryloyl group-containing monofunctional reactive monomers such as methyl (meth)acrylate, ethyl (meth)acrylate, n-butyl (meth)acrylate, hexyl (meth)acrylate, 2-ethylhexyl (meth)acrylate, lauryl (meth)acrylate, isobornyl (meth)acrylate, dicyclopentenyl (meth)acrylate, dicyclopentenyloxyethyl (meth)acrylate, phenyl (meth)acrylate, phenylcellosolve (meth)acrylate, 2-methoxyethyl (meth)acrylate, hydroxyethyl (meth)acrylate, hydroxypropyl (meth)acrylate, 2-acryloyloxyethyl hydrogen phthalate, dimethylaminoethyl (meth)acrylate, trifluoroethyl (meth)acrylate, and trimethylsiloxyethyl methacrylate, and prepolymers or oligomers having one or more of these as constituent monomers; monofunctional reactive monomers such as N-vinyl pyrrolidone and styrene; (meth)acryloyl group-containing bifunctional reactive monomers such as diethylene glycol di(meth)acrylate, neopentyl glycol di(meth)acrylate, 1,6-hexanediol di(meth)acrylate, polyethyleneglycol di(meth)acrylate, 2,2′-bis(4-(meth)acryloyloxypolyethyleneoxyphenyl)propane, and 2,2′-bis(4-(meth)acryloyloxypolypropyleneoxyphenyl)propane; (meth)acryloyl group-containing trifunctional reactive monomers such as trimethylolpropane tri(meth)acrylate and trimethylolethane tri(meth)acrylate; (meth)acryloyl group-containing tetrafunctional reactive monomers such as pentaerythritol tetra(meth)acrylate; and (meth)acryloyl group-containing hexafunctional monomers such as dipentaerythritol hexaacrylate, and resins having one or more of the above as the constituent monomers. One of these, or two or more in combination of these can be used as the active energy ray-curable resin.

The term (meth)acrylate herein means acrylate or methacrylate.

Examples of the compound having two or more isocyanate groups per molecule include methylenebis-4-cyclohexylisocyanate; polyisocyanates such as trimethylolpropane adduct of tolylene diisocyanate, trimethylolpropane adduct of hexamethylene diisocyanate, trimethylolpropane adduct of isophorone diisocyanate, isocyanurate of trilenediisocyanate, isocyanurate of hexamethylene diisocyanate, isocyanurate of isophorone diisocyanate, and biuret of hexamethylene diisocyanate; and urethane crosslinking agents such as blocked isocyanates of the above polyisocyanates. These may be used singly, or in combinations of two or more. During crosslinking, a catalyst such as dibutyltin dilaurate or dibutyltin diethylhexoate may be added to the reaction system as necessary.

Examples of the photopolymerization initiator include benzophenone compounds such as benzophenone, methyl-o-benzoylbenzoate, 4-methylbenzophenone, 4,4′-bis(diethylamino)benzophenone, methyl-o-benzoylbenzoate, 4-phenylbenzophenone, 4-benzoyl-4′-methyldiphenyl sulfide, 3,3′,4,4′-tetra(tert-butylperoxycarbonyObenzophenone, and 2,4,6-trimethylbenzophenone; benzoin compounds such as benzoin, benzoin methyl ether, benzoin ethyl ether, benzoin isopropyl ether, and benzyl methyl ketal; acetophenone compounds such as acetophenone, 2,2-dimethoxy-2-phenylacetophenone, and 1-hydroxycyclohexylphenyl ketone;

anthraquinone compounds such as methylanthraquinone, 2-ethylanthraquinone, and 2-amylanthraquinone; thioxanthone compounds such as thioxanthone, 2,4-diethylthioxanthone, and 2,4-diisopropylthioxanthone; alkylphenone compounds such as acetophenone dimethyl ketal; triazine compounds; biimidazole compounds; acylphosphine oxide compounds; titanocene compounds; oxime ester compounds; oxime phenylacetate compounds; hydroxy ketone compounds; and aminobenzoate compounds. These may be used singly, or in combinations of two or more.

According to at least one embodiment, the active energy ray-curable resin composition may contain one or more of additives as desired, within the limit not impairing the objects of the present invention, such as an antistatic agent, a surfactant, a leveling agent, a thixotropic additive, an antifouling agent, a printability improver, an antioxidant, a weather resistant stabilizer, a light resistant stabilizer, an ultraviolet absorber, a thermostabilizer, a colorant, and a filler.

According to at least one embodiment, the active energy ray-curable resin composition may further contain a solvent as necessary to be diluted to a concentration at which coating is easily applied. The solvent is not particularly limited as long as it does not react with the components of the curable resin composition or with other optional components or catalyze (facilitate) the self-reaction (including deterioration reaction) of these components. Examples of the solvent include 1-methoxy-2-propanol, ethyl acetate, n-butyl acetate, toluene, methyl ethyl ketone, methyl isobutyl ketone, diacetone alcohol, and acetone.

According to at least one embodiment, the active energy ray-curable composition of the component (b) can be obtained by mixing and stirring these components.

According to at least one embodiment, the (a) hard coat layer can be formed, using the transparent curable resin composition, by employing any web coating method such as roll coating, gravure coating, reverse coating, roll brush coating, spray coating, air knife coating, or die coating on the (β) poly(meth)acrylimide resin film layer as a web substrate.

According to at least one embodiment, the (α) hard coat layer of the laminate contains the white inorganic fine particles of the component (a) in a proportion of 1 to 50 parts by mass with respect to 100 parts by mass of the transparent curable resin of the component (b). When the component (a) is contained in a proportion of 50 parts by mass or less, the component (b) can load the component (a) in good conditions and hence the appearance of the laminate is favorable. The proportion of the component (a) is preferably 40 parts by mass or less, more preferably 30 parts by mass or less, and further preferably 20 parts by mass or less. When the component (a) is contained in a proportion of 1 part by mass or more, the blue light-blocking function can be expressed. The proportion of the component (a) is preferably 5 parts by mass or more, more preferably 10 parts by mass or more, and further preferably 15 parts by mass or more.

According to at least one embodiment, the (α) hard coat layer is characterized in that a difference between a refractive index of the white inorganic fine particles of the component (a) and a refractive index of the transparent curable resin of the component (b) is 0.1 or more. When the difference between a refractive index of the component (a) and a refractive index of the component (B) is 0.1 or more, the hard coat layer obtained, even when the blue light is blocked, is not tinted yellow, which is the complementary color of blue, and looks white and transparent. The larger a refractive index difference is, more preferable. The refractive index difference is preferably 0.2 or more.

According to at least one embodiment, the refractive index of the white inorganic fine particles of the component (a) is intended to herein mean a value obtained by preparing a transparent organic solvent dispersion, measuring a refractive index thereof at a temperature of 20° C. using sodium D line (with a wavelength of 589.3 nm), and extrapolating the obtained refractive index to 100% by volume of the white inorganic fine particles based on the specific gravities of the white inorganic fine particles and the organic solvent so as to calculate the value.

The refractive index of the transparent base resin of the component (b) is a value obtained by preparing a film composed only of the transparent base rein and measuring at a temperature of 20° C. using sodium D line (with a wavelength of 589.3 nm) in accordance with JIS K7142: 2008.

According to at least one embodiment, the thickness of the (α) hard coat layer is not particularly limited. When the laminate is used to be a face panel of a touch panel display, the thickness may be typically 15 μm or more, and preferably 20 μm or more, from the viewpoint of enhancing the surface hardness. Further, the thickness may be typically 100 μm or less, and preferably 50 μm or less, from the viewpoint of cutting processability and web handling of the laminate.

According to at least one embodiment, the above laminate has the (β) poly(meth)acrylimide resin film layer. The above (β) poly(meth)acrylimide resin film layer is preferably a multilayer film composed of a first poly(meth)acrylimide resin layer (β1); an aromatic polycarbonate resin layer (δ); and a second poly(meth)acrylimide resin layer (β2) superimposed directly in this sequence. “The first” and “the second” herein are conveniently termed only for the different arrangements and thus the components may be same or different. The (β3) poly(meth)acrylimide resin film preferably has good transparency. The total light transmittance (measured in accordance with JIS K7361-1: 1997 using, for example, a turbidity meter “NDH2000” (trade name) of Nippon Denshoku Industries Co., Ltd.) is preferably 80% or more, more preferably 85% or more, and further preferably 90% or more. The (β) poly(meth)acrylimide resin film preferably has good colorlessness. The yellowness index (measured in accordance with JIS K7105: 1981 using, for example, a colorimeter “SolidSpec-3700 (trade name),” manufactured by Shimadzu Corporation) of the film is preferably 3 or less, more preferably 2 or less, and further preferably 1 or less.

According to at least one embodiment, the poly(meth)acrylimide resin is a thermoplastic resin in which superiority of heat resistance and dimensional stability of polyimide resin is introduced while maintaining high transparency, high surface hardness, and high rigidity of acrylic resin, and the drawback of turning a light yellow color to a reddish brown color is modified. The poly(meth)acrylimide resin with these excellent properties is disclosed in, for example, JP 2011-519999 A. The term poly(meth)acrylimide herein means polyacrylimide or polymethacrylimide.

According to at least one embodiment, the poly(meth)acrylimide resin used in the above laminate is not particularly limited, as long as it has high transparency and is colorless for the purpose of using the laminate in optical articles.

Preferable examples of the poly(meth)acrylimide resin include those having a yellowness index (measured in accordance with JIS K7105: 1981) of 3 or less. The yellowness index is more preferably 2 or less, and further preferably 1 or less. Preferable examples of the poly(meth)acrylimide resin include, from the viewpoint of extrusion load and stability of a molten film made from the resin, those having a melt mass flow rate (measured in accordance with ISO1133 under the conditions of 260° C. and 98.07 N) of 0.1 to 20 g/10 min. The melt mass flow rate is more preferably 0.5 to 10 g/10 min. The poly(meth)acrylimide resin preferably has a glass transition temperature of 150° C. or more from the viewpoint of heat resistance. The glass transition temperature is more preferably 170° C. or more.

Thermoplastic resins other than the poly(meth)acrylimide resin; pigments, inorganic fillers, organic fillers, resin fillers; additives such as a lubricant, an antioxidant, a weather resistant stabilizer, a thermostabilizer, a release agent, an antistatic agent, and a surfactant; and the like may be used as desired with the above poly(meth)acrylimide resin within the limit not impairing the objects of the present invention. The amount of these optional components is typically about 0.01 to 10 parts by mass, based on 100 parts by mass of the poly(meth)acrylimide resin.

Examples of commercial products of the poly(meth)acrylimide resin include “PLEXIMID TT70 (trade name)” of EVONIK INDUSTRIES AG, or the like.

According to at least one embodiment, the thickness of the (β) poly(meth)acrylimide resin film layer is not particularly limited and can be any thickness as desired. When the laminate is used for a purpose other than a face panel of a touch panel display, the thickness thereof is typically 20 μm or more, preferably 50 μm or more, from the viewpoint of handleability of the laminate. The thickness of the laminate may be, from an economic perspective, typically 250 μm or less, and preferably 150 μm or less. When the laminate is used as a face panel of a touch panel display, the thickness thereof is, from the viewpoint of retaining rigidity, typically 100 μm or more, preferably 200 μm or more, and more preferably 250 μm or more. The thickness of the laminate may also be typically 1500 μm or less, preferably 1200 μm or less, and more preferably 1000 μm or less, from the viewpoint of satisfying the demand of making the touch panels thinner.

In the case where the (β) poly(meth)acrylimide resin film is a multilayer film composed of the β1 layer, the δ layer, and the β2 layer directly superimposed in this sequence, the thickness of each layer is not particularly limited and can be set to be any thickness as desired. When the laminate is used as a face panel of a touch panel display, the thickness of the β1 layer is not particularly limited but may be, from the viewpoint of maintaining high surface hardness, typically 20 μm or more, preferably 40 μm or more, and more preferably 60 μm or more. The thickness of the β2 layer is not particularly limited but, from the viewpoint of curl resistance, preferably the same thickness as that of the β1 layer. The thickness of the δ layer is not particularly limited but may be, from the viewpoint of cutting resistance, typically 20 μm or more, preferably 80 μm or more, and more preferably 120 μm or more.

According to at least one embodiment, the β1 layer and the β2 layer having “the same thickness” referred to herein should not be understood to be exactly the same thickness in a physicochemical sense. “The same thickness” should be understood to be the same thickness within the tolerance range expected during a typical industrial process and quality control. When the thicknesses are the same within the tolerance range expected during the typical industrial process and quality control, good curl resistance of the multilayer film can be maintained. In the case of a non-oriented multilayer film produced by the T-die co-extrusion method, the thicknesses of the layers are usually controlled within the range of about −5 to +5 μm during the process and quality control. Thus, the layer thicknesses 65 μm and 75 μm should be understood to be the same. “The same layer thickness” herein can be also paraphrased as “substantially the same layer thickness.”

According to at least one embodiment, the poly(meth)acrylimide resin used for the β1 layer and the poly(meth)acrylimide resin used for the β2 layer may have different resin properties. For example, poly(meth)acrylimide resins having different melt mass flow rates and glass transition temperatures may be used. However, it is preferable to use poly(meth)acrylimide resins having the same resin properties for these layers from the viewpoint of the curl resistance of the multilayer film. For example, use of poly(meth)acrylimide resins of the same grade from the same lot for these layers is one of preferable embodiments.

Examples of the aromatic polycarbonate resin used for the δ layer include one, and two or more in mixture, of aromatic polycarbonate resins such as polymers obtained by interfacial polymerization of an aromatic dihydroxy compound such as bisphenol A and 1,1-bis(4-hydroxyphenyl)-3,3,5-trimethylcyclohexane and phosgene; and polymers obtained by transesterification of an aromatic dihydroxy compound such as bisphenol A and 1,1-bis(4-hydroxyphenyl)-3,3,5-trimethylcyclohexane and a carbonic diester such as diphenyl carbonate.

The aromatic polycarbonate resin may be in the form of a composition containing other optional component(s). Preferable optional components that may be contained in the composition include a core-shell rubber. When the total mass of the aromatic polycarbonate resin and the core-shell rubber is 100 parts by mass, the use of the core-shell rubber in an amount of 0 to 30 parts by mass (and 100 to 70 parts by mass of the aromatic polycarbonate resin), preferably 0 to 10 parts by mass (and 100 to 90 parts by mass of the aromatic polycarbonate resin) can further enhance the cutting resistance and impact resistance of the aromatic polycarbonate resin layer.

Examples of the core-shell rubber to be used include one, and two or more in mixture, of methacrylate-styrene/butadiene rubber graft copolymers, acrylonitrile-styrene/butadiene rubber graft copolymers, acrylonitrile-styrene/ethylene-propylene rubber graft copolymers, acrylonitrile-styrene/acrylate graft copolymers, methacrylate/acrylate rubber graft copolymers, and methacrylate-acrylonitrile/acrylate rubber graft copolymers.

Optional components such as thermoplastic resins other than the aromatic polycarbonate resin and core-shell rubber; pigments, inorganic fillers, organic fillers, resin fillers; and additives such as a lubricant, an antioxidant, a weather resistant stabilizer, a thermostabilizer, a release agent, an antistatic agent, and a surfactant may be used as desired with the aromatic polycarbonate resin within the limit not impairing the objects of the present invention. The amount of these optional components is typically about 0.01 to 10 parts by mass, based on 100 parts by mass of the sum of the aromatic polycarbonate resin and core-shell rubber.

A method for producing the (β) poly(meth)acrylimide resin film are not particularly limited. Examples of the method include a method comprising (A) a step of preparing an apparatus equipped with an extruder and a T-die and continuously extruding a molten film of the (β) poly(meth)acrylimide resin from the T-die; and (B) a step of feeding and pressing the molten film of the above poly(meth)acrylimide resin between a first rotating or circulating mirror-finished body and a second rotating or circulating mirror-finished body.

According to at least one embodiment, the method for producing the multilayer film, in the case of the (β) poly(meth)acrylimide resin film being the above multilayer film, is similarly not limited. Examples of the method include a method comprising (A′) preparing a co-extruding apparatus equipped with an extruder and a T-die and continuously co-extruding from the T-die a molten film of the multilayer film composed of the first poly(meth)acrylimide resin layer (β1); the aromatic polycarbonate resin layer (δ); and the second poly(meth)acrylimide resin layer (β2) directly superimposed in this sequence; and (B′) a step of feeding and pressing the molten film of the above multilayer film between a first rotating or circulating mirror-finished body and a second rotating or circulating mirror-finished body.

For the above T-die used in step (A) or step (A′), any T-die can be used. Examples of the T-die include a manifold die, a fishtail die, and a coat hanger die.

Any type of co-extruding apparatus can be used as the above co-extruding apparatus. Examples of the co-extruding apparatus include a feed-block system co-extruding apparatus, a multimanifold system co-extruding apparatus, and a stacked plate system co-extruding apparatus.

Any extruder can be used as the above extruder in step (A) or step (A′). Examples of the extruder include a single screw extruder, a co-rotation twin screw extruder, and a counter-rotation twin screw extruder.

To prevent the poly(meth)acrylimide resin and the aromatic polycarbonate resin from deterioration, the inside of the extruder is preferably purged with nitrogen.

The poly(meth)acrylimide resin is a highly hygroscopic resin and thus preferably dried before being subjected to the film formation. It is also preferable that the poly(meth)acrylimide resin dried in a dryer be directly transferred and fed to an extruder from the dryer. A preset temperature of the dryer is preferably 100 to 150° C. The extruder also preferably has a vacuum vent disposed typically on a measurement zone at the tip of screw.

According to at least one embodiment, the temperature of the T-die used in step (A) or step (A′) is preferably set to be at least 260° C. to stably perform the step of continuously extruding or co-extruding the molten film of the (β) poly(meth)acrylimide resin film. The T-die temperature is more preferably 270° C. or more. The T-die temperature is also preferably set to be 350° C. or less to prevent the poly(meth)acrylimide resin and the aromatic polycarbonate resin from the deterioration.

According to at least one embodiment, the ratio (R/T) of a lip opening (R) to the thickness (T) of the above (β3) poly(meth)acrylimide resin film to be obtained is preferably 1 to 5. Such a ratio is more preferably 1.1 to 2.5. When the ratio (R/T) is 5 or less, the retardation can be controlled to be smaller. When the ratio (R/T) is 1 or more, the extrusion load can be maintained within a suitable range.

Examples of the above first mirror-finished body used in step (B) or step (B′) include a mirror-finished roll and a mirror-finished belt. Examples of the above second mirror-finished body include a mirror-finished roll and a mirror-finished belt.

According to at least one embodiment, the above mirror-finished roll has a roll whose surface is subjected to a mirror-finishing treatment. The roll is made of a metal, a ceramic, a silicon rubber, or the like. The surface of the mirror-finished roll may be subjected to, for the purpose of protecting from corrosion and scuffs, a chrome plating, an iron-phosphorus alloy plating, a hard carbon treatment by a PVD or CVD method, or the like. The term “mirror-finished” herein is not particularly limited and may be the surface processed to have a mirror-like condition by a known technique such as polishing using fine abrasive grains. For example, the first and/or the second mirror-finished body may have an arithmetic average roughness (Ra) of preferably 100 nm or less, and further preferably 50 nm or less. The first and/or the second mirror-finished body also may have, for example, a ten-point average roughness (Rz) of preferably 500 nm or less, and further preferably 200 nm or less.

According to at least one embodiment, the above mirror-finished belt has a belt whose surface is subjected to a mirror-finishing treatment, which is typically made from a seamless belt made of a metal. The mirror-finished belt is arranged, for example, to loop around a pair of belt rollers and circulate between them. The surface of the mirror-finished belt may be subjected to, for the purpose of protecting from corrosion and scuffs, a chrome plating, an iron-phosphorus alloy plating, a hard carbon treatment by a PVD or CVD method, or the like.

According to at least one embodiment, the film formation method described above is capable of providing the (β) poly(meth)acrylimide resin film excellent in transparency, surface smoothness, and appearance. The reason why the film with excellent properties can be obtained is believed as follows: when the molten film of the (β) poly(meth)acrylimide resin film is pressed between the first mirror-finished body and the second mirror-finished body, the highly smooth surface state of the first mirror-finished body and the second mirror-finished body is transferred to the film to correct faulty portions such as die streaks.

According to at least one embodiment, the surface temperature of the first mirror-finished body is preferably 100° C. or more for successful transfer of the surface state. The surface temperature of the first mirror-finished body is more preferably 120° C. or more, and further preferably 130° C. or more. The surface temperature of the first mirror-finished body is preferably 200° C. or less, and more preferably 160° C. or less to avoid the occurrence of a poor appearance (or exfoliation marks) caused when the film is peeled off from the first mirror-finished body.

According to at least one embodiment, the surface temperature of the second mirror-finished body is preferably 20° C. or more for successful transfer of the surface state. The surface temperature of the second mirror-finished body is more preferably 60° C. or more, and further preferably 100° C. or more. The surface temperature of the second mirror-finished body is preferably 200° C. or less, and more preferably 160° C. or less to avoid the occurrence of a poor appearance (or exfoliation marks) caused when the film is peeled off from the second mirror-finished body.

According to at least one embodiment, the surface temperature of the first mirror-finished body is preferably higher than the surface temperature of the second mirror-finished body. The reason is to make the film to be held on the first mirror-finished body and to be delivered to a following transfer roll.

When the (α) hard coat layer is formed, in order to enhance the adhesive strength between the hard coat and the (β) poly(meth)acrylimide resin film to be the transparent film substrate, the surface for the hard coat to be laminated of the (β) poly(meth)acrylimide resin film may previously be subjected to an easy-adhesion treatment such as a corona discharge treatment or an anchor coat formation.

When the corona discharge treatment is performed, a high interlayer bonding strength can be achieved with a wetting index (measured in accordance with JIS K6768: 1999) of typically 50 mN/m or more, and preferably 60 mN/m or more. An anchor coat layer may further be formed after the corona discharge treatment is carried out.

According to at least one embodiment, the corona discharge treatment involves passing the film between an insulated electrode and a dielectric roll, and applying a high-frequency high-voltage therebetween to generate a corona discharge thereby treating the film surface. The corona discharge ionizes oxygen and the like; and the ions collide against the film surface to cause the scission of resin molecule chains and the addition of oxygen-containing functional groups to resin molecule chains on the film surface, which can result in increase of the wetting index.

An amount of treatment (S) in the corona discharge treatment per unit area and unit time is determined from the viewpoint of achieving the wetting index falling within the above range and typically 80 W·min/m² or more, and preferably 120 W·min/m² or more. The amount of treatment (S) is also preferably controlled to 500 W·min/m² or less in order to prevent the film from deterioration. The amount of treatment (S) is more preferably 400 W·min/m² or less.

According to at least one embodiment, the amount of treatment (S) in the corona discharge treatment is defined by the following formula.

S=P/(L·V)

wherein
S: an amount of treatment (W·min/m²);
P: a discharge power (W);
L: a length of the discharge electrode (m); and
V: a line velocity (m/min).

According to at least one embodiment, the anchor coat agent for forming the anchor coat layer is not particularly limited, as long as it has high transparency and is colorless. For example, any known agent such as a polyester, an acrylic, a polyurethane, an acrylic urethane, and a polyester urethane may be used as the anchor coat agent. Among them, the thermoplastic urethane anchor coat agent is preferable from the viewpoint of enhancement of bonding strength to the hard coat layer.

A paint containing a silane coupling agent may also be used as the anchor coat agent. The silane coupling agent is preferably a silane compound having at least two different reactive groups selected from a hydrolyzable group (e.g., an alkoxy group such as a methoxy group and an ethoxy group; an acyloxy group such as an acetoxy group; and a halogen group such as a chloro group) and an organic functional group (e.g., an amino group, a vinyl group, an epoxy group, a methacryloxy group, an acryloxy group, and an isocyanate group). Such a silane coupling agent acts to enhance the bonding strength to the hard coat layer. Among them, a silane coupling agent having an amino group is preferable from the viewpoint of enhancement of bonding strength to the hard coat layer.

According to at least one embodiment, the paint containing the silane coupling agent may be one containing the silane coupling agent in a measure amount (i.e. 50% by mass or more on a solid basis). The silane coupling agent is preferably contained in the paint in an amount of 75% by mass or more of the solid content. More preferably, the proportion is 90% by mass or more.

Example of the silane coupling agent having an amino group include N-2-(aminoethyl)-3-aminopropyl methyldimethoxysilane, N-2-(aminoethyl)-3-aminopropyltrimethoxysilane, N-2-(aminoethyl)-3-aminopropyltriethoxysilane, 3-aminopropyltrimethoxysane, 3 -aminopropyltriethoxysane, 3-triethoxysilyl-N-(1,3-dimethyl-butylidene)propylamine, N-phenyl-3-aminopropyltrimethoxysilane, and N-(vinylbenzyl)-2-aminoethyl-3-aminopropyltrimethoxysilane. One of these, or two or more in combination of these can be used as the silane coupling agent having an amino group.

A method for forming the anchor coat layer is not particularly limited and a known web coating method can be used. Examples of the method include roll coating, gravure coating, reverse coating, roll brush coating, spray coating, air knife coating, and die coating. When the layer is formed, any diluent solvent such as methanol, ethanol, 1-methoxy-2-propanol, n-butyl acetate, toluene, methyl ethyl ketone, methyl isobutyl ketone, ethyl acetate, and acetone can be used as necessary.

According to at least one embodiment, the anchor coat agent may contain one or more of additives, within the limit not impairing the objects of the present invention, such as an antioxidant, a weather resistant stabilizer, a light resistant stabilizer, an ultraviolet absorber, a thermostabilizer, an antistatic agent, a surfactant, a colorant, an infrared light-blocking agent, a leveling agent, a thixotropic additive, and a filler.

According to at least one embodiment, the thickness of the anchor coat layer is typically about 0.01 to 5 μm, and preferably 0.1 to 2 μm.

According to at least one embodiment, the (α) hard coat layer of the laminate is not particularly limited to be a single layer but may be two or more layers. The (β) poly(meth)acrylimide resin film layer of the laminate is not particularly limited to be a single layer but may be two or more layers. The laminate may further comprise an optional layer(s) as desired other than the a layer and the β layer within the limit not impairing the objects of the present invention. Examples of the optional layer include a hard coat layer other than the a layer, an adhesive layer, an anchor coat layer, a transparent conductive film layer, a high refractive index layer, a low refractive index layer, an antireflection layer, and a transparent resin film layer other than the β layer.

According to another embodiment of the invention, the laminate includes a (β) poly(meth)acrylimide resin film layer and an (γ) adhesive layer, wherein the (γ) adhesive layer is formed of a transparent adhesive resin composition including (a) 1 to 50 parts by mass of white inorganic fine particles having an average particle size of 10 to 80 nm, and (b) 100 parts by mass of a transparent adhesive resin, wherein (1) a difference between a refractive index of the component (a) and a refractive index of the component (b) is 0.1 or more.

According to at least one embodiment, the (β) poly(meth)acrylimide resin film layer of the above laminate is as described above according to another embodiment of the invention. The (a) white inorganic fine particles having an average particle size of 10 to 80 nm, which is the component for the transparent adhesive resin composition for forming the adhesive layer of the laminate, is as described above according to another embodiment of the invention.

(c) Transparent Adhesive Resin

According to at least one embodiment, the transparent adhesive resin of the component (b) is a base resin of the transparent adhesive resin composition for forming the adhesive layer of the above laminate. The transparent adhesive resin is not particularly limited, as long as it is capable of forming an adhesive layer excellent in transparency and colorlessness. Examples thereof include acrylic pressure-sensitive adhesives, urethane pressure-sensitive adhesives, silicone pressure-sensitive adhesives, saturated copolymerized polyester adhesives, and unsaturated copolymerized polyester adhesives. One of these, or two or more in combination of these can be used for the transparent adhesive resin of the component (b).

According to at least one embodiment, the transparency and colorlessness of the adhesive layer cannot be affected only by the properties of the transparent adhesive resin, but also by the formation conditions such as other components, thickness, drying temperature, and irradiation dose of an active energy ray. The criterion of “the transparent adhesive resin capable of forming an adhesive layer with good transparency” is herein defined as being that the total light transmittance of the formed adhesive layer (measured in accordance with JIS K7361-1: 1997 using a turbidity meter “NDH2000” (trade name) of Nippon Denshoku Industries Co., Ltd.) is 80% or more, preferably 85% or more, and more preferably 90% or more. The criterion of “the transparent adhesive resin capable of forming an adhesive layer with good colorlessness” is herein defined as being that the color of the formed adhesive layer is “visually white.” The term “visually white” is herein intended to mean a color, which looks whiter than one of DN-85, D05-90A, D05-92B, D15-90A, D15-92B, D19-85A, D19-92B, D19-90C, D22-90B, D22-90C, D22-90D, D25-85A, D25-90B, D25-90C, D27-90B, D29-92B, D35-90A, D35-92B, D45-90A, D55-90A, D55-90B, D65-90A, D65-90B, D75-85A, D75-90B, D75-90D, D85-85A, D85-92B, D85-90D, and D95-90B when DN-95 of the Standard Paint Colors D-Edition issued by the Japan Paint Manufacturers Association is visually viewed through the formed adhesive layer. The term “visually white” preferably means a color looking whiter than all one of these colors. The term “visually white” more preferably means a color looking whiter than all one of these colors and looking whiter than DN-87.

According to at least one embodiment, the (γ) adhesive layer of the above laminate contains the white inorganic fine particles of the component (a) in a proportion of 1 to 50 parts by mass with respect to 100 parts by mass of the transparent adhesive resin of the component (b).

When the component (a) is contained in a proportion of 50 parts by mass or less, the component (b) can load the component (a) in good conditions and hence the appearance of the laminate is favorable. The proportion of the component (a) is preferably 40 parts by mass or less, more preferably 30 parts by mass or less, and further preferably 20 parts by mass or less. When the component (a) is contained in a proportion of 1 part by mass or more, the blue light-blocking performance can be expressed. The proportion of the component (a) is preferably 5 parts by mass or more, more preferably 10 parts by mass or more, and further preferably 15 parts by mass or more.

Further, the (γ) adhesive layer is characterized in that (2) a difference between a refractive index of the white inorganic fine particles of the component (a) and a refractive index of the transparent adhesive resin of the component (b) is 0.1 or more. When the difference between a refractive index of the component (a) and a refractive index of the component (b) is 0.1 or more, the adhesive layer formed, even when the blue light is blocked, is not tinted yellow, which is the complementary color of blue, and looks white and transparent. A larger refractive index difference is more preferable. The refractive index difference is preferably 0.2 or more.

According to at least one embodiment, the refractive index of the transparent adhesive resin of the component (b) is herein a value obtained by preparing a film composed only of a transparent adhesive rein and measuring at a temperature of 20° C. using sodium D line (with a wavelength of 589.3 nm) in accordance with JIS K7142: 2008. The refractive index of the white inorganic fine particles of the component (a) was described above according to another embodiment of the invention.

According to at least one embodiment, the transparent adhesive resin composition may contain one or more of additives as desired, within the limit not impairing the objects of the present invention, such as an antistatic agent, a surfactant, a leveling agent, a thixotropic additive, an antifouling agent, a printability improver, an antioxidant, a weather resistant stabilizer, a light resistant stabilizer, an ultraviolet absorber, a thermostabilizer, a colorant, and a filler.

According to at least one embodiment, the (γ) adhesive layer can be formed, using the transparent adhesive resin composition, by employing any web coating method such as roll coating, gravure coating, reverse coating, roll brush coating, spray coating, air knife coating, or die coating, on the (β) poly(meth)acrylimide resin film layer as a web substrate. When the layer is formed, a known diluent solvent such as methyl ethyl ketone, methyl isobutyl ketone, ethyl acetate, n-butyl acetate, isopropanol, and 1-methoxy-2-propanol can be used.

According to at least one embodiment, the thickness of the (γ) adhesive layer is not particularly limited but, considering the use of a known web coating method, typically 0.5 to 200 μm.

According to at least one embodiment, the (γ) adhesive layer of the above laminate is not particularly limited to be a single layer but may be two or more layers. The (β) poly(meth)acrylimide resin film layer of the laminate is not limited to be a single layer but may be two or more layers. The laminate may further comprise an optional layer(s) as desired other than the γ layer and the β layer within the limit not impairing the objects of the present invention. Examples of the optional layer include a hard coat layer, an adhesive layer other than the γ layer, an anchor coat layer, a transparent conductive film layer, a high refractive index layer, a low refractive index layer, an antireflection layer, and a transparent resin film layer other than the β layer.

The laminate according to various embodiments of the invention further includes an (α) hard coat layer, a (β) poly(meth)acrylimide resin film layer, and an (γ) adhesive layer. Each of these layers is not limited to be a single layer but may be two or more layers. The laminate may also comprise other optional layer(s) as described above.

### EXAMPLES

Embodiments of the invention are described below with reference to Examples, but is not particularly limited thereto.

Measurement and Evaluation Methods of Physical Properties

Blue Color-Blocking Rate

A sample (film or laminate) was placed so as not to closely contact with an integrating sphere and measured for transmission spectrum using a spectrophotometer “SolidSpec-3700” (trade name) of Shimadzu Corporation. The transmission spectrum of the blank was measured in the same manner. Blue color-blocking rate was calculated by the following formula.

Bc=(T₀−T₁)/T₀×100(%)

wherein
Bc: blue color-blocking rate (%)
T₀: transmittance (%) of a blank at a wavelength of 450 nanometers
T₁: transmittance (%) of a sample at a wavelength of 450 nanometers

Visible Light Transmittance

Transmission spectrum was measured using a spectrophotometer “SolidSpec-3700” (trade name) of Shimadzu Corporation. The visible light transmittance was calculated as a proportion of the integrated area of the transmission spectrum at wavelengths from 380 to 780 nanometers with respect to the integrated area of the transmission spectrum on the assumption that the transmittance at any point in the whole range from wavelengths 380 to 780 nanometers is 100%.

Visual Color 1

A sample (film or laminate) was placed on an Apple smartphone “iPhone 5” (trade name) in a white case to visually observe the color tone of the screen and the color tone of the white case and evaluate in accordance with the following criteria.
◯: No color tone difference is noted before and after the sample is placed.
X: Significant color tone difference is noted before and after the sample is placed.

Visual Color 2

DN-95 of the Standard Paint Colors D-Edition of the Japan Paint Manufacturers Association was visually observed through the sample (film or laminate) and evaluated in terms of the color number corresponding to the Standard Paint Colors D-Edition of the Japan Paint Manufacturers Association. When no corresponding color number was applicable, the closest color number and the difference from the color represented by such a number were noted. (No note is provided when there is a corresponding color number.)

Surface Appearance (Evaluation Method 1)

The film having the (B-1) described below as the transparent base resin of the component (B) was visually observed as fluorescent light, at various different incidence angles, was flashed on the layer surface provided with the blue light-blocking function, and evaluated in accordance with the following criteria.

The film composed of the (B-2) described below to be the transparent base resin of the component (B) was visually observed as fluorescent light, at various different incidence angles, was flashed on the surface (both sides), and evaluated in accordance with the following criteria.

The laminate was visually observed as fluorescent light, at various different incidence angles, was flashed on the surface on the hard coat layer side, and evaluated in accordance with the following criteria.
⊚: The surface exhibited no undulations nor flaws, and even when being held up nearby to the light, no impression of cloudiness.

◯: When being looked closely into, the surface had a few recognized undulations and flaws. When being held up nearby to the light, a slight impression of cloudiness was exhibited.

Δ: The surface had recognized undulations and flaws, and gave an impression of cloudiness.

X: The surface had a large number of recognized undulations and flaws, and also gave a definite impression of cloudiness.

Surface Appearance (Evaluation Method 2)

The film having the (B-3) described below as the transparent base resin of the component (B) was visually observed as fluorescent light, at various different incidence angles, was flashed on the layer surface provided with the blue light-blocking function, and evaluated in accordance with the following criteria.
⊚: The surface exhibited no undulations nor lines, and even when being held up nearby to the light, no impression of cloudiness.

◯: When being looked closely into, the surface had a few recognized undulations and lines. When being held up nearby to the light, a slight impression of cloudiness was exhibited.

Δ: The surface had recognized undulations and lines, and gave an impression of cloudiness.

X: The surface had a large number of recognized undulations and lines, and also gave a definite impression of cloudiness.

Linear Expansion Coefficient

A linear expansion coefficient of the laminate was measured in accordance with JIS K7197: 1991. A thermal mechanical analysis apparatus (TMA) “EXSTAR6000” (trade name) of Seiko Instruments Inc. was used. A test piece, sized to have a 20 mm lengthwise and a 10 mm crosswise, was cut out so that the machine direction of the laminate accorded with the longitudinal direction of the test piece. The test piece condition was regulated at a temperature of 23° C.±2° C. and a relative humidity of 50±5% for 24 hours. The condition at the measurement highest temperature was not regulated for the purpose of measuring the dimensional stability as the physical property value of the laminate. The distance between chucks was set to be 10 mm and the temperature was programmed so that the temperature was maintained at 20° C. for 3 minutes and subsequently increased to 270° C. at a temperature elevation rate of 5° C./min. The linear expansion coefficient was calculated from the obtained temperature −test piece length curve, with the low temperature side being 30° C. and the high temperature side being 250° C.

Blue Light-Blocking Film Obtained from the Resin Composition

Raw Materials Used

(A) White inorganic fine particles

(A-1) Rutile titanium oxide

Average particle size of 35 nm, refractive index of 1.72

(A-2) Rutile titanium oxide

Average particle size of 50 nm, refractive index of 1.72

(A-3) Rutile titanium oxide

Average particle size of 10 nm, refractive index of 1.72

(A-4) Rutile titanium oxide

Average particle size of 80 nm, refractive index of 1.72

(A-5) Zinc oxide

Average particle size of 35 nm, refractive index of 1.95

(A-6) Aluminum oxide

Average particle size of 40 nm, refractive index of 1.76

(A′) Comparative inorganic fine particles

(A′-1) Rutile titanium oxide

White inorganic fine particles, average particle size of 1.2 nm, refractive index of 1.72 (A′-2) Rutile titanium oxide

White inorganic fine particles, average particle size of 270 nm, refractive index of 1.72

(A′-3) Bismuth oxide

Yellow inorganic fine particles, average particle size of 30 nm, refractive index of 1.90

(B) Transparent base resin

(B-1) An active energy ray-curable resin composition obtained by mixing and stirring 80 parts by mass of the following (B1), 20 parts by mass of the following (B2), and 6.5 parts by mass of the following (B3): refractive index of 1.48

(B₁) Dipentaerythritol hexaacrylate

(B₂) Hexanediol diacrylate

(B₃) A phenyl ketone photopolymerization initiator (1-hydroxycyclohexyl phenyl ketone) “SB-PI714” (trade name) of Shuang-Bang Ind. Corp.

(B-2) A transparent polyester resin “KODAR PETG 6763” (trade name) of Eastman Chemical Company: refractive index of 1.57.

(B-3) An acrylic pressure-sensitive adhesive “SK-Dyne 2094” (trade name) of Soken Chemical & Engineering Co., Ltd: refractive index of 1.48.

### Example 1

The resin composition was obtained by mixing and stirring 20 parts by mass of the above (A-1), 100 parts by mass of the above (B-1), and 50 parts by mass of methyl isobutyl ketone. The resin composition was applied, using a gravure coating apparatus, to one side of “Lumirror U” (trade name), thickness of 50 μm, a biaxially oriented polyethylene terephthalate film of Toray Industries, Inc., so that the thickness when dried was 6 μm to obtain a blue light-blocking film. As described above, the tests on blue color-blocking rate, visible light transmittance, visual colors, and surface appearance were carried out. The results are shown in Table 1.

### Examples 2 to 6

The films were formed and tested and evaluated for physical properties in the same manner as in Example 1, except that the white inorganic fine particles shown in Table 1 were used in place of the above (A-1). The results are shown in Table 1.

Comparative Examples 1 to 3

The films were formed and tested and evaluated for physical properties in the same manner as in Example 1, except that the comparative inorganic fine particles shown in Table 4 were used in place of the above (A-1). The results are shown in Table 4.

Examples 7 to 11, and Comparative Examples 4 and 5

The films were formed and tested and evaluated for physical properties in the same manner as in Example 1, except that the contents of the above (A-1) were changed as shown in Table 2 or 4. The results are shown in Table 2 or 4.

### Example 12

15 parts by mass of the above (A-1) and 100 parts by mass of the above (B-2) were melted and kneaded using a twin screw extruder under the condition of a die outlet temperature of 240° C. to obtain the resin composition of the present invention. Using the resin composition and using a T-die film extruding apparatus equipped with an extruder, a T-die, and a winder having rotating mirror-finished rolls and a mirror-finished belt circulating along the outer circumference surface of the mirror-finished rolls at a T-die outlet resin temperature of 240° C. a 40 μm-thick blue light-blocking film was obtained. As described above, the tests on blue color-blocking rate, visible light transmittance, visual colors, and surface appearance were carried out. The results are shown in Table 2.

### Example 13

The film was formed and tested and evaluated for physical properties in the same manner as in Example 12, except that the content of the above (A-1) was changed as shown in Table 3. The results are shown in Table 3.

### Examples 14 and 15

The films were formed and tested and evaluated for physical properties in the same manner as in Example 12, except that the white inorganic fine particles shown in Table 3 were used in place of the above (A-1). The results are shown in Table 3.

### Example 16

The resin composition of the present invention was obtained by mixing and stirring 20 parts by mass of the above (A-1), 100 parts by mass of the above (B-3), and 50 parts by mass of ethyl acetate. The resin composition was applied, using a gravure coating apparatus, to one side of “Lumirror U” (trade name), a biaxially oriented polyethylene terephthalate film having a thickness 50 of μm, of Toray Industries, Inc., so that the thickness when dried was 45 μm to obtain a blue light-blocking film. As described above, the tests on blue color-blocking rate, visible light transmittance, visual colors, and surface appearance were carried out. The results are shown in Table 3.

### Example 17

The film was formed and tested and evaluated for physical properties in the same manner as in Example 16, except that the content of the above (A-1) was changed as shown in Table 3. The results are shown in Table 3.

### Example 18

The film was formed and tested and evaluated for physical properties in the same manner as in Example 16, except that the above (A-2) was used in place of the above (A-1). The results are shown in Table 3.

TABLE 1

| | | Example 1 | Example 2 | Example 3 | Example 4 | Example 5 | Example 6 |
|---|---|---|---|---|---|---|---|
| Formulation | (A-1) | 20 | | | | | |
| | (A-2) | | 20 | | | | |
| | (A-3) | | | 20 | | | |
| | (A-4) | | | | 20 | | |
| | (A-5) | | | | | 20 | |
| | (A-6) | | | | | | 20 |
| | (A′ -1) | | | | | | |
| | (A′ -2) | | | | | | |
| | (A′ -3) | | | | | | |
| | (B-1) | 100 | 100 | 100 | 100 | 100 | 100 |
| | (B-2) | | | | | | |
| | (B-3) | | | | | | |
| | (i) Average particle size nm | 35 | 50 | 10 | 80 | 35 | 50 |
| | (ii) Refractive index difference | 0.24 | 0.24 | 0.24 | 0.24 | 0.47 | 0.28 |
| Evaluation | Blue color-blocking rate % | 20 | 22 | 15 | 25 | 26 | 21 |
| results | Visible light transmittance % | 87 | 86 | 90 | 80 | 84 | 86 |
| | Visual color 1 | ◯ | ◯ | ◯ | ◯ | ◯ | ◯ |
| | Visual color 2 | DN-95 | DN-95 | DN-95 | DN-95 | DN-95 | DN-95 |
| | Surface appearance | ⊚ | ⊚ | ⊚ | ◯ | ⊚ | ⊚ |

TABLE 2

| | | Example 7 | Example 8 | Example 9 | Example 10 | Example 11 | Example 12 |
|---|---|---|---|---|---|---|---|
| Formulation | (A-1) | 5 | 10 | 15 | 30 | 40 | 15 |
| | (A-2) | | | | | | |
| | (A-3) | | | | | | |
| | (A-4) | | | | | | |
| | (A-5) | | | | | | |
| | (A-6) | | | | | | |
| | (A′ -1) | | | | | | |
| | (A′ -2) | | | | | | |
| | (A′ -3) | | | | | | |
| | (B-1) | 100 | 100 | 100 | 100 | 100 | |
| | (B-2) | | | | | | 100 |
| | (B-3) | | | | | | |
| | (i) Average particle size nm | 35 | 35 | 35 | 35 | 35 | 35 |
| | (ii) Refractive index difference | 0.24 | 0.24 | 0.24 | 0.24 | 0.24 | 0.15 |
| Evaluation | Blue color-blocking rate % | 9 | 12 | 17 | 24 | 30 | 13 |
| results | Visible light transmittance % | 91 | 89 | 88 | 84 | 80 | 90 |
| | Visual color 1 | ◯ | ◯ | ◯ | ◯ | ◯ | ◯ |
| | Visual color 2 | DN-95 | DN-95 | DN-95 | DN-95 | DN-95 | DN-95 |
| | Surface appearance | ⊚ | ⊚ | ⊚ | ◯ | ◯ | ⊚ |

TABLE 3

| | | Example 13 | Example 14 | Example 15 | Example 16 | Example 17 | Example 18 |
|---|---|---|---|---|---|---|---|
| Formulation | (A-1) | 20 | | | 15 | 20 | |
| | (A-2) | | 15 | | | | 15 |
| | (A-3) | | | | | | |
| | (A-4) | | | | | | |
| | (A-5) | | | 20 | | | |
| | (A-6) | | | | | | |
| | (A′ -1) | | | | | | |
| | (A′ -2) | | | | | | |
| | (A′ -3) | | | | | | |
| | (B-1) | | | | | | |
| | (B-2) | 100 | 100 | 100 | | | |
| | (B-3) | | | | 100 | 100 | 100 |
| | (i) Average particle size nm | 35 | 50 | 35 | 35 | 35 | 50 |
| | (ii) Refractive index difference | 0.15 | 0.15 | 0.38 | 0.24 | 0.24 | 0.24 |
| Evaluation | Blue color-blocking rate % | 15 | 15 | 21 | 20 | 22 | 22 |
| results | Visible light transmittance % | 88 | 88 | 86 | 87 | 85 | 85 |
| | Visual color 1 | ◯ | ◯ | ◯ | ◯ | ◯ | ◯ |
| | Visual color 2 | DN-95 | DN-95 | DN-95 | DN-95 | DN-95 | DN-95 |
| | Surface appearance | ⊚ | ⊚ | ⊚ | ⊚ | ⊚ | ⊚ |

TABLE 4

| | | Comparative | Comparative | Comparative | Comparative | Comparative |
|---|---|---|---|---|---|---|
| | | Example 1 | Example 2 | Example 3 | Example 4 | Example 5 |
| Formulation | (A-1) | | | | 0.1 | 60 |
| | (A-2) | | | | | |
| | (A-3) | | | | | |
| | (A-4) | | | | | |
| | (A-5) | | | | | |
| | (A-6) | | | | | |
| | (A′ -1) | 20 | | | | |
| | (A′ -2) | | 20 | | | |
| | (A′ -3) | | | 20 | | |
| | (B-1) | 100 | 100 | 100 | 100 | 100 |
| | (B-2) | | | | | |
| | (B-3) | | | | | |
| | (i) Average particle size nm | 1.2 | 270 | 30 | 35 | 35 |
| | (ii) Refractive index difference | 0.24 | 0.24 | 0.42 | 0.24 | 0.24 |
| Evaluation | Blue color-blocking rate % | 8 | 68 | 70 | 7 | 40 |
| results | Visible light transmittance % | 91 | 70 | 84 | 92 | 75 |
| | Visual color 1 | ◯ | X | X | ◯ | X |
| | Visual color 2 | DN-95 | DN-95 | D27-90F | DN-95 | DN-95 |
| | (Note on visual color 2) | — | White turbidity | — | — | White turbidity |
| | Surface appearance | ⊚ | X | ⊚ | ⊚ | X |

The blue color-blocking films obtained from the resin compositions of the present invention had good blue light-blocking property and a high visible light transmittance and did not damage the color tone of the screen or white case. These films also had good surface appearance. The film of Comparative Example 1, however, had insufficient blue light-blocking property due to too small particle sizes of the white inorganic fine particles. The film of Comparative Example 2 had a low visible light transmittance due to too large particle sizes of the white inorganic fine particles. This film was also opaque white, resulting in a low visual color evaluation and consequently had poor surface appearance. The film of Comparative Example 3 had lowered color tone of the screen and white case because of the yellow color from the yellow inorganic fine particles used. The film of Comparative Example 4 had insufficient blue light-blocking property due to too small a content of the white inorganic fine particles. The film of Comparative Example 5 had a low visible light transmittance due to too large a content of the white inorganic fine particles. The film was also opaque white, resulting in a low visual color evaluation and consequently had poor surface appearance.

[Laminate]

Raw Materials Used

(a) White inorganic fine particles having an average particle size of 10 to 80 nm

(a-1) Rutile titanium oxide: average particle size of 35 nm, refractive index of 1.72

(a-2) Rutile titanium oxide: average particle size of 50 nm, refractive index of 1.72

(a-3) Rutile titanium oxide: average particle size of 10 nm, refractive index of 1.72

(a-4) Rutile titanium oxide: average particle size of 80 nm, refractive index of 1.72

(a-5) Zinc oxide: average particle size of 35 nm, refractive index of 1.95

(a-6) Aluminum oxide: average particle size of 40 nm, refractive index of 1.76

(a′) Comparative inorganic fine particles

(a′-1) Rutile titanium oxide

White inorganic fine particles, average particle size of 1.2 nm, refractive index of 1.72

(a′-2) Rutile titanium oxide

White inorganic fine particles, average particle size of 270 nm, refractive index of 1.72

(a′-3) Bismuth oxide

Yellow inorganic fine particles, average particle size of 30 nm, refractive index of 1.90

(b) Transparent curable resin

(b-1) An active energy ray-curable resin composition (refractive index of 1.48) obtained by mixing and stirring 65 parts by mass of dipentaerythritol hexaacrylate, 35 parts by mass of hexanediol diacrylate, and 6.5 parts by mass of a phenyl ketone photopolymerization initiator (1-hydroxycyclohexyl phenyl ketone) “SB-PI714” (trade name) of Shuang-Bang Ind. Corp.

(c) Transparent adhesive resin

(c-1) An acrylic pressure-sensitive adhesive “SK-Dyne 2094” (trade name) of Soken Chemical & Engineering Co., Ltd., refractive index of 1.48

(β) Poly(meth)acrylimide Resin Film

(β-1) Using poly(meth)acrylimide “PLEXIMID TT70” (trade name) available from EVONIK INDUSTRIES AG and using an apparatus equipped with a 50 mm extruder (a double flight screw having an L/D=29 and a CR=1.86 was mounted thereon); a T-die having a die width of 680 mm; and a winder having a mechanism in which a molten film was pressed between mirror-finished rolls and a mirror-finished belt, a 250 μm-thick film was formed. The preset conditions at this operation included preset extruder temperatures of C1/C2/C3/AD=280/300/320/320° C.; a preset T-die temperature of 320° C.; a T-die lip opening of 0.5 mm; a preset minor-finished roll temperature of 140° C.; a preset mirror-finished belt temperature of 120° C.; a minor-finished belt pressing force of 1.4 MPa; and a taking-out speed of 5.6 m/min.

(β-2) An apparatus used was equipped with an extruder 1 (a 50 mm extruder, a double flight screw having an L/D=29 and a CR=1.86 was mounted thereon); an extruder 2 (a 50 mm extruder, a double flight screw having an L/D=29 and a CR=1.86 was mounted thereon); a 2-kind 3-layer multimanifold co-extrusion T-die having a die width of 680 mm; and a winder having a mechanism in which a molten film was pressed between mirror-finished rolls and a minor-finished belt. Poly(meth)acrylimide, “PLEXIMID TT70” (trade name) of EVONIK INDUSTRIES AG, to be both outer layers (β1 layer, β2 layer) of the multilayer film using the extruder 1 and aromatic polycarbonate, “CALIBRE-301-4” (trade name) of Sumika Styron Polycarbonate Limited, to be the middle layer (δ layer) of the multilayer film using the extruder 2 were continuously co-extruded from the co-extrusion T-die, fed between the rotating mirror-finished rolls and the mirror-finished belt circulating along the outer circumference surface of the mirror-finished rolls so that the β1 layer faced the mirror-finished roll side, and pressed to form a multilayer film having the 80 μm-thick β1 layer, the 90 μm-thick δ layer, and the 80 μm-thick β2 layer. The preset conditions at this operation included preset extruder 1 temperatures of C1/C2/C3/C4/C5/AD=260/290 to 290° C.; preset extruder 2 temperatures of C1/C2/C3/C4/C5/AD=260/280 to 280/260/270° C.; a preset T-die temperature of 300° C.; a T-die lip opening of 0.5 mm; a preset mirror-finished roll temperature of 130° C.; a preset mirror-finished belt temperature of 120° C.; a mirror-finished belt pressing force of 1.4 MPa; and a taking-out speed of 6.5 m/min.

(β′) Comparative transparent film base

(β′-1) A biaxially oriented polyethylene terephthalate film “DIAFOIL” (trade name) of Mitsubishi Plastics, Inc., thickness of 250 μm

(β′-2) An acrylic resin film “Technolloy” (trade name) of Sumitomo Chemical Co.,

Ltd., thickness of 250 μm

(β′-3) Using aromatic polycarbonate “CALIBRE-301-4” (trade name) of Sumika Styron Polycarbonate Limited and using an apparatus equipped with a 50 mm extruder (a double flight screw having an L/D=29 and a CR=1.86 was mounted thereon); a T-die having a die width of 680 mm; and a winder having a mechanism in which a molten film was pressed between mirror-finished rolls and a mirror-finished belt, a 250 μm-thick film was formed. The preset conditions at this operation included preset extruder temperatures of C1/C2/C3/AD=280/300/320/320° C.; a preset T-die temperature of 320° C.; a T-die lip opening of 0.5 mm; a preset mirror-finished roll temperature of 140° C.; a preset mirror-finished belt temperature of 120° C.; a mirror-finished belt pressing force of 1.4 MPa; and a taking-out speed of 5.6 m/min.

### Example 19

Using the transparent curable resin composition obtained by mixing and stirring 20 parts by mass of the above (a-1), 100 parts by mass of the above (b-1), and 50 parts by mass of methyl isobutyl ketone, a hard coat layer was formed on one side of the above (β-1) using a gravure coating apparatus to have a thickness of 20 μm, whereby a laminate was obtained. As described above, the tests on blue color-blocking rate, visible light transmittance, visual colors, surface appearance, and a linear expansion coefficient were carried out. The results are shown in Table 5.

### Examples 20 to 24

The laminates were formed and tested and evaluated for physical properties in the same manner as in Example 19, except that the white inorganic fine particles shown in Table 5 were used in place of the above (a-1). The results are shown in Table 5.

### Comparative Examples 6 to 8

The laminates were formed and tested and evaluated for physical properties in the same manner as in Example 19, except that the comparative inorganic fine particles shown in Table 7 were used in place of the above (a-1). The results are shown in Table 7.

### Example 25

The laminate was formed and tested and evaluated for physical properties in the same manner as in Example 19, except that the above (β-2) was used in place of the above (β-1) and a hard coat layer was formed on the β1 layer side. The results are shown in Table 5.

Examples 26 to 30, and Comparative Examples 9 and 10

The laminates were formed and tested and evaluated for physical properties in the same manner as in Example 25, except that the contents of the above (a-1) were changed as shown in one of Tables 5 to 7. The results are shown in one of Tables 5 to 7.

### Reference Example 1

The laminate was formed and tested and evaluated for physical properties in the same manner as in Example 19, except that the above (β′-1) was used in place of the above (β-1). The results are shown in Table 7. The linear expansion coefficient was not measurable due to a remarkable shrinking of the laminate.

### Reference Example 2

The laminate was formed and tested and evaluated for physical properties in the same manner as in Example 19, except that the above (β′-2) was used in place of the above (β-1). The results are shown in Table 7.

### Reference Example 3

The laminate was formed and tested and evaluated for physical properties in the same manner as in Example 19, except that the above (β′-3) was used in place of the above (β-1). The results are shown in Table 7.

### Example 31

Using the transparent adhesive resin composition obtained by mixing and stirring 20 parts by mass of the above (a-1), 100 parts by mass of the above (c-1), and 50 parts by mass of ethyl acetate, an adhesive layer was formed on the surface of the β2 layer side of the above (β-2) using a gravure coating apparatus to have a thickness of 45 μm when dried, whereby a laminate was obtained. As described above, the tests on blue color-blocking rate, visible light transmittance, visual colors, surface appearance, and linear expansion coefficient were carried out. The results are shown in Table 6.

### Example 32

Using the transparent adhesive resin composition obtained by mixing and stirring 20 parts by mass of the above (a-1), 100 parts by mass of the above (c-1), and 50 parts by mass of ethyl acetate, an adhesive layer was formed on the surface of the β2 layer side of the above (β-2) using a gravure coating apparatus to have a thickness of 45 μm when dried. Additionally, using the transparent curable resin composition free of the component (a) obtained by mixing and stirring 100 parts by mass of the above (b-1) and 50 parts by mass of methyl isobutyl ketone, a hard coat layer was formed on the surface of the β1 layer side using a gravure coating apparatus to have a thickness of 20 μm, whereby a laminate was obtained. As described above, the tests on blue color-blocking rate, visible light transmittance, visual colors, surface appearance, and linear expansion coefficient were carried out. The results are shown in Table 6.

### Example 33

The laminate was formed and tested and evaluated for physical properties in the same manner as in Example 32, except that the content of the above (a-1) was changed as shown in Table 6. The results are shown in Table 6.

### Example 34

The laminate was formed and tested and evaluated for physical properties in the same manner as in Example 32, except that the above (a-2) was used in place of the above (a-1). The results are shown in Table 6.

TABLE 5

| | | Example 19 | Example 20 | Example 21 | Example 22 | Example 23 | Example 24 | Example 25 | Example 26 |
|---|---|---|---|---|---|---|---|---|---|
| Formulation | (a-1) | 20 | | | | | | 20 | 5 |
| for α layer | (a-2) | | 20 | | | | | | |
| or γ layer | (a-3) | | | 20 | | | | | |
| | (a-4) | | | | 20 | | | | |
| | (a-5) | | | | | 20 | | | |
| | (a-6) | | | | | | 20 | | |
| | (a′ -1) | | | | | | | | |
| | (a′ -2) | | | | | | | | |
| | (a′ -3) | | | | | | | | |
| | (b-1) | 100 | 100 | 100 | 100 | 100 | 100 | 100 | 100 |
| | (c-1) | | | | | | | | |
| Note | Average particle | 35 | 50 | 10 | 80 | 35 | 50 | 35 | 35 |
| | size nm | | | | | | | | |
| | Refractive index | 0.24 | 0.24 | 0.24 | 0.24 | 0.47 | 0.28 | 0.24 | 0.24 |
| | difference | | | | | | | | |
| | β layer | β -1 | β -1 | β -1 | β -1 | β -1 | β -1 | β -2 | β -2 |
| Evaluation | Blue color- | 20 | 22 | 15 | 25 | 22 | 21 | 20 | 11 |
| results | blocking rate % | | | | | | | | |
| | Visible light | 87 | 86 | 90 | 80 | 87 | 86 | 87 | 91 |
| | transmittance % | | | | | | | | |
| | Visual color 1 | ◯ | ◯ | ◯ | ◯ | ◯ | ◯ | ◯ | ◯ |
| | Visual color 2 | DN-95 | DN-95 | DN-95 | DN-95 | DN-95 | DN-95 | DN-95 | DN-95 |
| | Note on visual | — | — | — | — | — | — | — | — |
| | color 2 | | | | | | | | |
| | Surface appearance | ⊚ | ⊚ | ⊚ | ◯ | ⊚ | ⊚ | ⊚ | ⊚ |
| | Linear expansion | 15 | 15 | 15 | 15 | 15 | 15 | 15 | 15 |
| | coefficient ppm | | | | | | | | |

TABLE 6

| | | Example 27 | Example 28 | Example 29 | Example 30 | Example 31 | Example 32 | Example 33 | Example 34 |
|---|---|---|---|---|---|---|---|---|---|
| Formulation | (a-1) | 10 | 15 | 30 | 40 | 15 | 15 | 20 | |
| for α layer | (a-2) | | | | | | | | 15 |
| or γ layer | (a-3) | | | | | | | | |
| | (a-4) | | | | | | | | |
| | (a-5) | | | | | | | | |
| | (a-6) | | | | | | | | |
| | (a′ -1) | | | | | | | | |
| | (a′ -2) | | | | | | | | |
| | (a′ -3) | | | | | | | | |
| | (b-1) | 100 | 100 | 100 | 100 | | | | |
| | (c-1) | | | | | 100 | 100 | 100 | 100 |
| Note | Average particle | 35 | 35 | 35 | 35 | 35 | 35 | 35 | 35 |
| | size nm | | | | | | | | |
| | Refractive index | 0.24 | 0.24 | 0.24 | 0.24 | 0.24 | 0.24 | 0.24 | 0.24 |
| | difference | | | | | | | | |
| | β layer | β -2 | β -2 | β -2 | β -2 | β -2 | β -2 | β -2 | β -2 |
| Evaluation | Blue color- | 14 | 17 | 24 | 30 | 20 | 20 | 22 | 22 |
| results | blocking rate % | | | | | | | | |
| | Visible light | 89 | 88 | 84 | 80 | 87 | 87 | 85 | 85 |
| | transmittance % | | | | | | | | |
| | Visual color 1 | ◯ | ◯ | ◯ | ◯ | ◯ | ◯ | ◯ | ◯ |
| | Visual color 2 | DN-95 | DN-95 | DN-95 | DN-95 | DN-95 | DN-95 | DN-95 | DN-95 |
| | Note on visual | — | — | — | — | — | — | — | — |
| | color 2 | | | | | | | | |
| | Surface appearance | ⊚ | ⊚ | ◯ | ◯ | — | ⊚ | ⊚ | ⊚ |
| | Linear expansion | 15 | 15 | 15 | 15 | — | 15 | 15 | 15 |
| | coefficient ppm | | | | | | | | |

TABLE 7

| | | Comparative | Comparative | Comparative | Comparative | Comparative | Reference | Reference | Reference |
|---|---|---|---|---|---|---|---|---|---|
| | | Example 6 | Example 7 | Example 8 | Example 9 | Example 10 | Example 1 | Example 2 | Example 3 |
| Formulation | (a-1) | | | | 0.1 | 60 | 20 | 20 | 20 |
| for α layer | (a-2) | | | | | | | | |
| or γ layer | (a-3) | | | | | | | | |
| | (a-4) | | | | | | | | |
| | (a-5) | | | | | | | | |
| | (a-6) | | | | | | | | |
| | (a′ -1) | 20 | | | | | | | |
| | (a′ -2) | | 20 | | | | | | |
| | (a′ -3) | | | 20 | | | | | |
| | (b-1) | 100 | 100 | 100 | 100 | 100 | 100 | 100 | 100 |
| | (c-1) | | | | | | | | |
| Note | Average particle | 1.2 | 270 | 30 | 35 | 35 | 35 | 35 | 35 |
| | size nm | | | | | | | | |
| | Refractive index | 0.24 | 0.24 | 0.42 | 0.24 | 0.24 | 0.24 | 0.24 | 0.24 |
| | difference | | | | | | | | |
| | β layer | β -1 | β -1 | β -1 | β -2 | β -2 | β′ -1 | β′ -2 | β′ -3 |
| Evaluation | Blue color- | 8 | 68 | 22 | 7 | 40 | 20 | 20 | 20 |
| results | blocking rate % | | | | | | | | |
| | Visible light | 91 | 70 | 88 | 92 | 75 | 87 | 87 | 87 |
| | transmittance % | | | | | | | | |
| | Visual color 1 | ◯ | X | X | ◯ | X | ◯ | ◯ | ◯ |
| | Visual color 2 | DN-95 | DN-95 | D27-90F | DN-95 | DN-95 | DN-95 | DN-95 | DN-95 |
| | Note on visual | — | White | — | — | White | — | — | — |
| | color 2 | | turbidity | | | turbidity | | | |
| | Surface appearance | ⊚ | X | ⊚ | ⊚ | X | ⊚ | ⊚ | ⊚ |
| | Linear expansion | 15 | 15 | 15 | 15 | 15 | Unmeasurable | 80 | 70 |
| | coefficient ppm | | | | | | | | |

The laminates of the present invention had good blue light-blocking function and were white and transparent and did not look yellow. These laminates are excellent in transparency, surface hardness, rigidity, heat resistance, and dimensional stability.

The laminate of Comparative Example 6, however, had insufficient blue light-blocking function because the particle sizes of the white inorganic fine particles were smaller than the specific lower limit. The laminate of Comparative Example 7 had insufficient transparency because the particle sizes of the white inorganic fine particles were larger than the specific upper limit. The laminate of Comparative Example 8 looked yellow because the yellow inorganic fine particles were used. The laminate of Comparative Example 9 had insufficient blue light-blocking function because the content of the white inorganic fine particles was less than the specific lower limit. The laminate of Comparative Example 10 had insufficient transparency because the content of the white inorganic fine particles was more than the specific upper limit. The laminates of Reference Examples 1 to 3 did not comprise any poly(meth)acrylimide resin film layer, and thus the linear expansion coefficient was large or not measurable and the heat resistance and dimensional stability were poor.

Embodiments of the invention provide a resin composition which has a good blue light-blocking function and is white and transparent and does not look yellow. Consequently, the resin composition can be suitably used for optical articles such as a blue light-blocking film for an LED display, sunglasses, and anti-glare glasses.

The poly(meth)acrylimide resin laminate according to various embodiments of the invention has a good blue light-blocking function and is white and transparent and does not look yellow. The poly(meth)acrylimide resin laminate is also excellent in transparency, surface hardness, rigidity, heat resistance, and dimensional stability. Thus, the poly(meth)acrylimide resin laminate can be suitably used for optical articles such as a blue light-blocking member for an LED display, a face panel with a blue light-blocking function, sunglasses, and anti-glare glasses.

Embodiments of the invention may suitably comprise, consist or consist essentially of the elements disclosed and may be practiced in the absence of an element not disclosed. For example, it can be recognized by those skilled in the art that certain steps can be combined into a single step.

Unless defined otherwise, all technical and scientific terms used have the same meaning as commonly understood by one of ordinary skill in the art to which this invention belongs.

The singular forms “a,” “an,” and “the” include plural referents, unless the context clearly dictates otherwise.

As used herein and in the appended claims, the words “comprise,” “has,” and “include” and all grammatical variations thereof are each intended to have an open, non-limiting meaning that does not exclude additional elements or steps.

“Optionally” means that the subsequently described event or circumstances may or may not occur. The description includes instances where the event or circumstance occurs and instances where it does not occur. As used herein, terms such as “first” and “second” are arbitrarily assigned and are merely intended to differentiate between two or more components of an apparatus. It is to be understood that the words “first” and “second” serve no other purpose and are not part of the name or description of the component, nor do they necessarily define a relative location or position of the component. Furthermore, it is to be understood that the mere use of the term “first” and “second” does not require that there be any “third” component, although that possibility is contemplated under the scope of the embodiments of the present invention.

Ranges may be expressed herein as from about one particular value, and/or to about another particular value. When such a range is expressed, it is to be understood that another embodiment is from the one particular value and/or to the other particular value, along with all combinations within said range.

All publications mentioned are incorporated by reference to disclose and describe the methods or materials, or both, in connection with which the publications are cited. The publications discussed are provided solely for their disclosure prior to the filing date of the present application. Nothing is to be construed as an admission that the invention is not entitled to antedate such publication by virtue of prior invention. Further, the dates of publication provided may be different from the actual publication dates, which may need to be independently confirmed.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

1. A resin composition, comprising:
(A) 1 to 50 parts by mass of white inorganic fine particles; and
(B) 100 parts by mass of a transparent base resin,
wherein (i) an average particle size of the white inorganic fine particles is 10 to 80 nm, and (ii) a difference between a refractive index of the white inorganic fine particles and a refractive index of the base resin is 0.1 or more.

2. The resin composition according to claim 1, wherein the component (B) is a transparent curable resin.

3. The resin composition according to claim 1, wherein the component (B) is a transparent thermoplastic resin.

4. The resin composition according to claim 1, wherein the component (B) is a transparent adhesive.

5. A laminate comprising:
(α) a hard coat layer and (β) a poly(meth)acrylimide resin film layer,
wherein the (α) hard coat layer is formed of a transparent curable resin composition comprising:
(a) 1 to 50 parts by mass of white inorganic fine particles having an average particle size of 10 to 80 nm; and
(b) 100 parts by mass of a transparent curable resin, and
wherein (1) a difference between a refractive index of the component (a) and a refractive index of the component (b) is 0.1 or more.

6. A laminate comprising:
(β) a poly(meth)acrylimide resin film layer; and (γ) an adhesive layer, wherein the (γ) adhesive layer is formed of a transparent adhesive resin composition comprising:
(a) 1 to 50 parts by mass of white inorganic fine particles having an average particle size of 10 to 80 nm; and
(b) 100 parts by mass of a transparent adhesive resin,
wherein (1) a difference between a refractive index of the component (a) and a refractive index of the component (b) is 0.1 or more.

7. The laminate according to claim 5 or 6, wherein
the (β) poly(meth)acrylimide resin film layer is a multilayer film having
a first poly(meth)acrylimide resin layer (β);
an aromatic polycarbonate resin layer (δ); and
a second poly(meth)acrylimide resin layer (β2) directly superimposed in this sequence.

8. A blue light-blocking film formed of the resin composition according to any one of claims 1 to 4.

9. A blue light-blocking member comprising the resin composition according to any one of claims 1 to 4 or the laminate according to any one of claims 5 to 7.

10. An article with the blue light-blocking member according to claim 9 used therein.

11. Use of the resin composition according to any one of claims 1 to 4 or the laminate according to any one of claims 5 to 7 for a blue light-blocking member.
